(19) United States
(12) Patent Application Publication
(10) Pub. No.: US 2025/0371539 A1
(43) Pub. Date: Dec. 4, 2025

(54) SYSTEMS AND METHODS FOR DYNAMIC GENERATION OF SECURITY CODES FOR INSTRUMENT UTILIZATIONS

(71) Applicant: Synchrony Bank, Stamford, CT (US)

(72) Inventors: David Chau, Stamford, CT (US); Tarun Saha, Stamford, CT (US); Richard Carrasco, Stamford, CT (US); Brian Keller, Stamford, CT (US); Casey Wheeler, Stamford, CT (US)

(21) Appl. No.: 19/222,105

(22) Filed: May 29, 2025

Related U.S. Application Data
(60) Provisional application No. 63/652,852, filed on May 29, 2024.

(51) Int. Cl. G06Q 20/40; G06Q 20/38; H04L 9/08; H04L 9/32

(52) U.S. Cl. CPC G06Q 20/401; G06Q 20/3827; H04L 9/085; H04L 9/3236

(57) ABSTRACT

Systems and methods provide a framework through which dynamic verification values are generated for different instruments for use in real-time instrument utilizations. In response to an authorization request associated with an instrument and including a dynamic verification value, a system obtains a secret code associated with the instrument. The system dynamically generates a reference dynamic verification value using record data associated with the instrument, the secret code, and a current time interval. The reference dynamic verification value is compared to the received dynamic verification value to determine if these values match. If so, the system fulfills the authorization request.

### CROSS REFERENCE TO RELATED APPLICATIONS

This application claims priority to U.S. Provisional Patent Application 63/652,852, filed May 29, 2024, which is incorporated by reference herein in its entirety.

### FIELD

The present disclosure relates generally to a framework through which dynamic verification values are generated for different instruments for use in real-time instrument utilizations.

### SUMMARY

Disclosed embodiments provide a framework through which dynamic verification values are generated for different instruments for use in real-time instrument utilizations. According to some embodiments, a computer-implemented method is provided. The computer-implemented method comprises receiving an authorization request associated with a payment instrument. The authorization request includes record data and a dynamic verification value corresponding to the payment instrument. The computer-implemented method further comprises obtaining a secret code associated with the payment instrument. The secret code is obtained using the record data. The computer-implemented method further comprises dynamically generating a reference dynamic verification value corresponding to the payment instrument. The reference dynamic verification value is dynamically generated by processing the record data, the secret code, and a current time interval through a hashing algorithm. The computer-implemented method further comprises comparing the dynamic verification value to the reference dynamic verification value. The computer-implemented method further comprises fulfilling the authorization request when the dynamic verification value matches the reference dynamic verification value.

In some embodiments, the record data includes a portion of a Universally Unique Identifier (UUID) corresponding to the payment instrument.

In some embodiments, the computer-implemented method further comprises receiving a request to enable generation of dynamic verification values for the payment instrument. The request includes the secret code and the record data. The computer-implemented method further comprises storing the secret code and the record data. The computer-implemented method further comprises transmitting a response. When the response is received at a user device, the user device uses the record data and the secret code to generate new dynamic verification values.

In some embodiments, the payment instrument is associated with a static verification value. Further, the dynamic verification value and the static verification value have a same format.

In some embodiments, the dynamic verification value is generated as a result of the record data being obtained from the payment instrument through a wireless communications session.

In some embodiments, the computer-implemented method further comprises comparing the dynamic verification value to a static verification value associated with the payment instrument when the dynamic verification value does not match the reference dynamic verification value. The computer-implemented method further comprises fulfilling the authorization request when the dynamic verification value matches the static verification value.

In some embodiments, the secret code is a shared secret generated through a secure communications session with an application executing on a user device. Further, the shared secret is generated in response to detection of the payment instrument through the application.

In an example, a system comprises one or more processors and memory including instructions that, as a result of being executed by the one or more processors, cause the system to perform the processes described herein. In another example, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 shows an illustrative example of an environment in which an authorization request including a dynamic verification value associated with a payment instrument is processed for a pending instrument utilization in accordance with at least one embodiment;

FIG. 2 shows an illustrative example of an environment in which a secret code is generated between a payment instrument service application and a dynamic verification value code microservice for generation of dynamic verification values in accordance with at least one embodiment;

FIGS. 3A-3B show an illustrative example of an environment in which dynamic verification values for a payment instrument are automatically updated at pre-defined time intervals in accordance with at least one embodiment;

FIG. 4 shows an illustrative example of a process for dynamically generating dynamic verification values for a payment instrument in accordance with at least one embodiment;

FIG. 5 shows an illustrative example of a process for generating and presenting a dynamic verification value associated with a payment instrument for an instrument utilization in accordance with at least one embodiment;

FIG. 6 shows an illustrative example of a process for evaluating an authorization request associated with a payment instrument and including a dynamic verification value to determine whether to fulfill the authorization request in accordance with at least one embodiment; and

FIG. 7 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide a framework through which dynamic verification values are generated for different instruments for use in real-time instrument utilizations. These dynamic verification values may be generated according to a secret code shared between a payment instrument service application through which payment instruments may be processed and a payment instrument service that processes authorization requests for instrument utilizations.

Payment instruments traditionally include static card verification values (CVV) that are printed or otherwise displayed on the obverse or reverse of payment instruments. These static CVVs, in some instances, may be three- or four-digit numbers that are printed or otherwise presented on the obverse or reverse of payment instruments along with unique identifiers (e.g., primary account numbers, etc.) associated with the payment instruments. Thus, a static CVV printed or otherwise presented on a payment instrument may be immutable until a replacement payment instrument is issued (e.g., the payment instrument is expired, a user reports the payment instrument as being lost or stolen, etc.). However, the replacement payment instrument, while likely having a new verification value printed or otherwise presented on the replacement payment instrument, will still have a static verification value that is also immutable for the duration of the replacement payment instrument.

An unauthorized user gaining access to a payment instrument may, thus, have access to the static CVV printed or otherwise presented on the payment instrument. Until the payment instrument is expired or is reported lost or stolen, the unauthorized user may use the payment instrument for fraudulent transactions, as payment instrument services and authorization processors may rely on static CVVs for authorization of transactions associated with different payment instruments. This can result in fraudulent transactions being erroneously processed, reducing the efficiency of the various computer systems implemented by these payment instrument services and authorization processors as they may expend computing resources in processing these fraudulent transactions. Thus, there is a need for different verification values that may dynamically change over time and/or when used for different instrument utilizations.

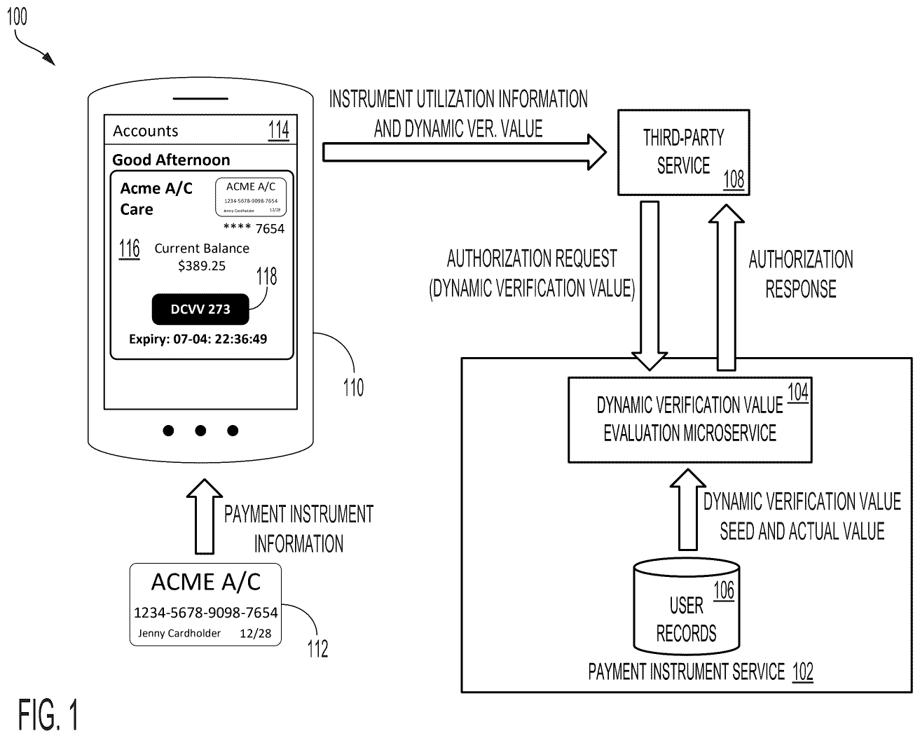

FIG. 1 shows an illustrative example of an environment 100 in which an authorization request including a dynamic verification value 118 associated with a payment instrument 112 is processed for a pending instrument utilization in accordance with at least one embodiment. In the environment 100, a user device 110 implements a payment instrument service application 114 through which a dynamic verification value 118 associated with a payment instrument 112 is dynamically generated by the payment instrument service application 114. The payment instrument service application 114 may be provided by a payment instrument service 102 that processes applications for payment instruments, issues payment instruments, determines user-specific allowances to payment instruments, processes instrument utilizations associated with payment instruments, processes cancellations of accounts associated with payment instruments, and performs other such operations.

In an embodiment, the payment instrument service 102 exposes an application programming interface (API) through which users (such as the user of the user device 110) can submit one or more API calls to an authentication microservice (not shown) implemented by the payment instrument service 102 to obtain record data corresponding to different payment instruments issued by the payment instrument service 102 to these users. The payment instrument service application 114, in some instances, may allow the user of the user device 110, to access one or more payment instrument records associated with their payment instruments. For instance, through the payment instrument service application 114, a user may provide a set of credentials (e.g., username and password, cryptographic key, one-time password (OTP), etc.) that are associated with one or more payment instruments issued to the user by the payment instrument service 102. The payment instrument service application 114, through the API exposed by the payment instrument service 102, may transmit a request (i.e., an API call) to the authentication microservice implemented by the payment instrument service 102 to retrieve any record data associated with the user's payment instruments. This request may include the provided set of credentials and identifying information associated with the user (e.g., a username, an electronic mail address, etc.).

In response to the request from the payment instrument service application 114, the authentication microservice may evaluate the provided set of credentials to determine whether the corresponding user may be authenticated and, if so, is authorized to access the associated payment instrument record data. For instance, the authentication microservice, in response to the API call from the payment instrument service application 114, may automatically query a payment instrument repository maintained by the authentication microservice to determine whether the provided set of credentials corresponds to a particular user record associated with the user of the user device 110. If the provided set of credentials is not associated with an existing payment instrument (e.g., the set of credentials do not match the known set of credentials associated with the payment instrument, the set of credentials is expired, etc.), the authentication microservice may deny the request and transmit a response to the payment instrument service application 114 that provides an indication of the user authentication failure. Accordingly, the payment instrument service application 114 may indicate, to the user, that their request could not be fulfilled.

If the authentication microservice successfully authenticates the user, the authentication microservice may retrieve any available record data from the payment instrument repository and provides the record data to the payment instrument service application 114 for presentation to the user. For instance, from the payment instrument repository maintained by the authentication microservice, the authentication microservice may retrieve balance information corresponding to each payment instrument associated with the user and issued by the payment instrument service 102. This balance information, for each payment instrument, may indicate a current balance (if any) associated with the payment instrument, information corresponding to any required payments (e.g., minimum payment amount, payment due date, etc.), and the like. Further, the authentication microservice may retrieve any additional information associated with the payment instrument that may be useful to the user (e.g., available credit amount, remaining credit amount, most recent payment information, etc.).

As illustrated in FIG. 1, the payment instrument service application 114 may use the available record data corresponding to the payment instrument 112 to update an instrument interface 116. For example, through the instrument interface 116, the payment instrument service application 114 may provide the user with their current balance (if any) associated with the payment instrument 112. Further, the payment instrument service application 114 may provide, through the instrument interface 116, identifying information associated with the payment instrument 112 (e.g., the name of the entity or brand with whom the payment instrument 112 is associated, a graphical representation of the payment instrument 112, a portion of the identifier associated with the payment instrument 112, etc.).

In an embodiment, the payment instrument service application 114 provides, through the instrument interface 116 and for the payment instrument 112, a dynamic verification value 118 that may be used as a credential for authorization of instrument utilizations associated with the payment instrument 112. For various instrument utilizations, a verification value associated with the payment instrument 112 may need to be provided along with the unique identifier associated with the payment instrument 112 (including the Issuer Identification Number (IIN) and the account number assigned by the payment instrument service 102) and any instrument utilization details (e.g., utilization amount, description of objects being obtained during the utilization, etc.) for authorization of the instrument utilization. Traditionally, a payment instrument (such as payment instrument 112), may include a static verification value that is printed or otherwise presented on the payment instrument itself. This static verification value, in some instances, may be a three- or four-digit number that is printed or otherwise presented on the obverse or reverse of the payment instrument 112 along with the unique identifier associated with the payment instrument 112. Accordingly, the static verification value on the payment instrument 112 may be immutable until a replacement payment instrument 112 is issued to the user for the corresponding user record (e.g., the payment instrument 112 is expired, the user reports the payment instrument 112 as being lost or stolen, etc.). However, the replacement payment instrument 112, while likely having a new verification value printed or otherwise presented on the replacement payment instrument 112, will still have a static verification value that is also immutable for the duration of the replacement payment instrument 112.

In an embodiment, to generate and present dynamic verification values 118 for the payment instrument 112, the payment instrument service 102 implements, through the payment instrument service application 114, executable code and corresponding libraries that, when executed by the payment instrument service application 114, cause the payment instrument service application 114 to dynamically generate dynamic verification values 118 for an enrolled payment instrument 112. In an embodiment, when the payment instrument service application 114 is executed on the user device 110 for the first time or otherwise upon execution of the executable code and corresponding libraries, the payment instrument service application 114 automatically interacts with the operating system and any peripheral devices of the user device 110 to determine whether the user device 110 supports wireless communications protocols for establishing wireless communications sessions. For example, if the payment instrument 112 implements a Radio Frequency Identification (RFID) transponder or tag that automatically emits encoded data, the payment instrument service application 114 may automatically interact with the operating system and any peripheral devices of the user device 110 to determine whether the user device 110 implements any Near-Field Communication (NFC) protocols that may be used to detect, receive, and process such encoded data emitted by the payment instrument 112 through the RFID transponder or tag.

It should be noted that while NFC protocols are described extensively throughout the present disclosure for the purpose of illustration, other communications methods may be implemented to securely obtain encoded data from payment instruments, such as payment instrument 112, according to the communication capabilities of these payment instruments. For instance, if the payment instrument service 102 issues payment instruments that are capable of transmitting encoded data using Bluetooth® signals and/or other wireless signals, the payment instrument service application 114 may automatically interact with the operating system and any peripheral devices of the user device 110 to determine whether the user device 110 is capable of detecting and receiving encoded data through Bluetooth® and/or other wireless signal protocols.

In an embodiment, if the user device 110 implements an NFC protocol through which the user device 110 may detect and receive short-range RFID signals, the payment instrument service application 114, through the instrument interface 116, can generate a prompt to bring the payment instrument 112 within range of the user device 110 to detect the short-range RFID signals emitted by the payment instrument 112. In response to receiving a short-range RFID signal through the NFC protocol, the payment instrument service application 114 may automatically, and in real-time or near real-time, verify that the payment instrument 112 is associated with an existing payment instrument record maintained by the authentication microservice. For instance, if the user of the user device 110 has been authenticated by the authentication microservice through the payment instrument service application 114, the payment instrument service application 114 may compare the record data obtained from the payment instrument 112 through the NFC protocol to the record data obtained from the authentication microservice and associated with the user's known payment instruments. If the payment instrument service application 114 determines that the record data from the payment instrument 112 is not associated with the record data obtained from the authentication microservice, the payment instrument service application 114 may automatically transmit the record data obtained from the payment instrument 112 to the authentication microservice for authentication of the payment instrument 112. If the authentication microservice is unable to authenticate the record data obtained from the payment instrument 112 through the NFC protocol, the authentication microservice may return an indication that authentication of the payment instrument 112 has failed. Accordingly, the payment instrument service application 114 may update the instrument interface 116 to indicate that enrollment for dynamic verification values has failed and that the user is to contact the payment instrument service 102 to address this authentication failure.

By requiring implementation of a wireless communications session in order to obtain record data associated with a payment instrument 112 for enrollment of the payment instrument 112 for dynamic verification values, the network security of the payment instrument service 102 and of the payment instrument service application 114 is enhanced. For instance, by requiring this wireless communications session, the payment instrument service 102 (through the payment instrument service application 114) can verify that the user of the payment instrument service application 114 is also in possession of the payment instrument 112. Thus, if the user is not in possession of the payment instrument 112, the payment instrument service 102 automatically prevent enrollment of the payment instrument 112 for generation of dynamic verification values and may thus limit use of the payment instrument 112 for different transactions.

If the payment instrument service application 114 determines that the record data obtained from the payment instrument 112 according to the NFC or other short-range communications protocol is authentic (e.g., the record data corresponds to an existing payment instrument 112 associated with a payment instrument record, etc.), the payment instrument service application 114 may enroll the payment instrument 112 for generation of dynamic verification values. For example, in an embodiment, once the payment instrument 112 has been authenticated, the payment instrument service application 114 dynamically generates a secret code that, along with record data associated with the payment instrument 112, may be used as input into a hashing algorithm to generate dynamic verification codes for the payment instrument 112. For example, in an embodiment, the secret code is generated by the payment instrument service application 114 unilaterally. Alternatively, the secret code may be a shared secret established between the payment instrument service application 114 and the payment instrument service 102 through a symmetric-key algorithm, a Diffie-Hellman key exchange scheme, or any other suitable cryptographic method. In some instances, the secret code is a universally unique identifier (UUID), which may also be referred to as a globally unique identifier (GUID). A UUID may be generated using any suitable technique for generating a unique identifier. A UUID may not be mathematically guaranteed to be unique, but may have a probability of being not unique that is low enough to be considered unique within the context of payment instruments issued by the payment instrument service 102. As an example, the UUID generated by the payment instrument service application 114 to serve as the secret code for the payment instrument 112 may be a version 4 UUID, which includes thirty-two hexadecimal characters representing 128 bits. In one or more embodiments, the bits that comprise the version 4 UUID are randomly generated. Therefore, there are 2¹²⁸ possible combinations of bits, leaving the probability that two such generated UUIDs are the same very low within reasonable time and computation power constraints. A UUID used as the secret code may be generated using other techniques for UUID generation. For example, a version 1 UUID is generated based on a Media Access Control (MAC) address of a computing device (or component therein) in combination with an exact time of generation and the record data associated with a payment instrument, which would not be duplicated unless the two UUIDs were generated using the same device, having the same MAC address, at the same time and for the same payment instrument 112. Any other technique for generating a UUID may be used without departing from the scope of embodiments described herein.

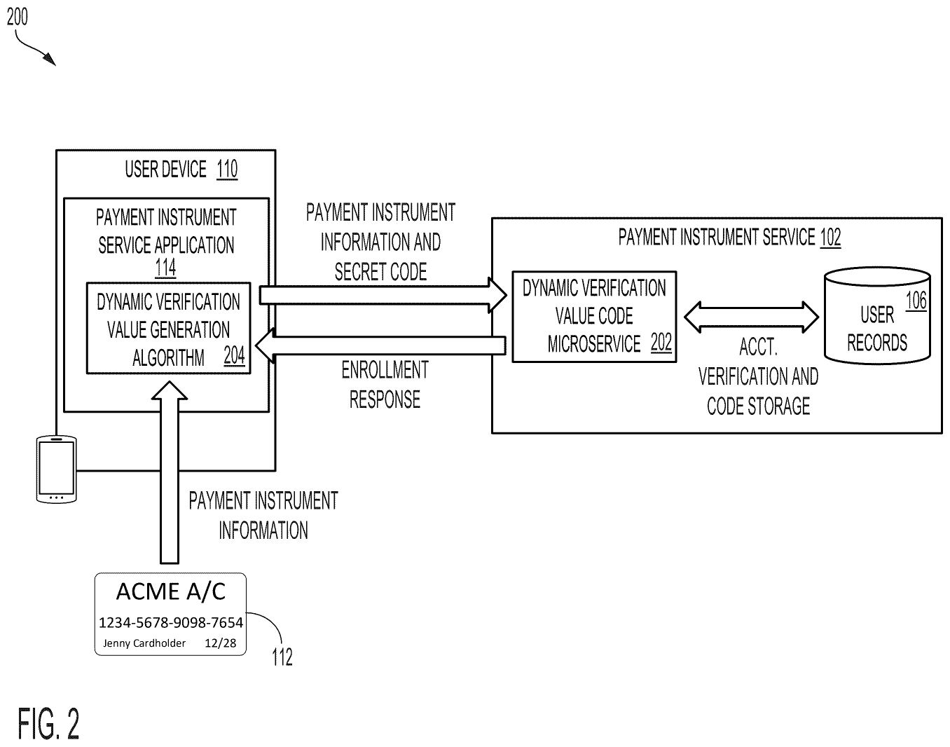

In an embodiment, once the payment instrument service application 114 has generated a new secret code for the payment instrument 112, the payment instrument service application 114 transmits an API call to a dynamic verification value code microservice implemented by the payment instrument service 102 (as illustrated and described in greater detail herein in relation to FIG. 2) to provide the new secret code and any obtained record data associated with the payment instrument 112 as obtained through the NFC or other short-range communications protocol. This record data may include a UUID or other unique identifier corresponding to the payment instrument record associated with the payment instrument 112, a payment instrument record type, a user identifier corresponding to the user to whom the payment instrument 112 was issued, and the like. In response to receiving the secret code and the record data from the payment instrument service application 114, the dynamic verification value code microservice may determine whether an existing secret code is already associated with the payment instrument record corresponding to the payment instrument 112. For instance, the dynamic verification value code microservice may access a user record associated with the holder of the payment instrument 112 from the user records repository 106 to determine whether the user record includes an existing secret code for the payment instrument 112.

If the payment instrument record corresponding to the payment instrument 112 and included in the user record is already associated with an existing secret code, the dynamic verification value code microservice may transmit a notification to the payment instrument service application 114 to indicate that dynamic verification values cannot be generated by the payment instrument service application 114 for the payment instrument 112. In response to this notification, the payment instrument service application 114 may update the instrument interface 116 to indicate that enrollment for dynamic verification values has failed and that the user is to contact the payment instrument service 102 to enable generation of dynamic verification values for their payment instrument 112. This further enhances the network security of the payment instrument service 102 as this may prevent fraudulent use of the payment instrument 112 by unauthorized users that may have gained access to the payment instrument 112 and to the payment instrument service application 114. For example, by requiring the user to contact the payment instrument service 102 to enable generation of dynamic verification values for their payment instrument 112, the payment instrument service 102 may perform a more rigorous vetting process to authenticate the user and the payment instrument 112 prior to enabling enrollment of the payment instrument 112 for generation of dynamic verification values. If the user cannot be properly vetted by the payment instrument service 102, the user may be prevented from enrolling the payment instrument 112 for generation of dynamic verification values, thereby reducing the risk of fraudulent transactions being processed by the payment instrument service 102.

If the dynamic verification value code microservice determines that the payment instrument record corresponding to the payment instrument 112 is not associated with an existing secret code, the dynamic verification value code microservice may automatically store the secret code and the record data associated with the payment instrument 112 in the user records repository 106 and in association with the user record of the user. The dynamic verification value code microservice may further transmit a notification to the payment instrument service application 114 to indicate that the payment instrument service application 114 may dynamically generate new dynamic verification values for the payment instrument 112. Accordingly, the payment instrument service application 114 may use the secret code, at least a portion of the UUID or other unique identifier corresponding to the payment instrument record associated with the payment instrument 112 (e.g., the last four digits of the payment instrument number presented on the payment instrument 112, etc.), and data corresponding to a current time interval as input to a hashing algorithm to generate a dynamic verification value for the payment instrument 112. The payment instrument service application 114 may update the instrument interface 116 corresponding to the payment instrument 112 to present the newly generated dynamic verification value 118 to the user.

In addition to presenting the dynamic verification value 118 for the payment instrument 112 through the instrument interface 116, the payment instrument service application 114 may indicate the expiration time and date for the dynamic verification value 118. For example, as illustrated in FIG. 1, the dynamic verification value “273” may be set to expire on July 4 at 10:36:49 P.M. (e.g., 22:36:49 in 24-hour notation). In an embodiment, the payment instrument service application 114 may be configured to automatically generate a new dynamic verification value 118 at defined time intervals such that, at the conclusion of a particular time interval, the payment instrument service application 114 automatically uses the secret code, the portion of the UUID or other unique identifier corresponding to the payment instrument 112, and the new time interval as input to the hashing algorithm to generate a new dynamic verification value 118. Returning to the illustrative example provided in FIG. 1, if the payment instrument service application 114 determines that the current time is 10:36:49 P.M. on July 4, the payment instrument service application 114 may determine that the present dynamic verification value “273” is expired and that a new dynamic verification value is to be generated. Accordingly, the payment instrument service application 114 may generate and present, through the instrument interface 116, a new dynamic verification value by executing the aforementioned hashing process.

By automatically implementing a temporal limitation to dynamic verification values generated by the payment instrument service application 114, the payment instrument service 102 further enhances its network security. For instance, if an unauthorized user were to gain access to the payment instrument 112 and a dynamic verification value generated at a particular time, this unauthorized user would have a limited window of time to use the payment instrument 112 for different transactions, as this dynamic verification value may automatically expire after a pre-determined period of time. Thus, the number of fraudulent transactions that may be processed by the payment instrument service 102 for this payment instrument 112 may be significantly reduced as fraudulent transactions that do not include the valid dynamic verification value at a given time may be automatically rejected by the payment instrument service 102. This, in turn, may improve the efficiency of the various computer systems of the payment instrument service 102 as the number of transactions that may require various processing capabilities of the payment instrument service 102 and other services (e.g., authorization processors, etc.) is reduced through automatic rejection of transactions not associated with valid dynamic verification values.

In an embodiment, the dynamic verification value 118 is configured to share the same format as the static verification value printed or otherwise presented on the payment instrument 112. For instance, if the payment instrument service 102 implements, for the payment instrument 112, a three-digit static verification value, the hashing algorithm implemented by the payment instrument service application 114 for generating dynamic verification values may be configured to also generate three-digit dynamic verification values for the payment instrument 112. Similarly, if the payment instrument service 102 implements, for the payment instrument 112, a four-digit static verification value, the hashing algorithm implemented by the payment instrument service application 114 for generating dynamic verification values may be configured to also generate four-digit dynamic verification values for the payment instrument 112. In an embodiment, when the payment instrument service application 114 receives record data from the payment instrument 112 through the NFC or other short-range communications protocol, the payment instrument service application 114 processes the record data to determine the format of the static verification value implemented on the payment instrument 112. Based on this evaluation, the payment instrument service application 114 may automatically select the hashing algorithm that corresponds to the identified format for generation of new dynamic verification values for the payment instrument 112.

The dynamic verification value 118 presented through the instrument interface 116 may be used in place of the static verification value on the payment instrument 112 for any instrument utilizations involving the payment instrument 112 and for which authorization of the instrument utilizations is required. For example, if the user of the user device 110 and the holder of the payment instrument 112 engages in an instrument utilization with a third-party service 108 (e.g., an online marketplace, a point-of-sale system, a merchant, etc.) and the third-party service 108 requests a verification value associated with the payment instrument 112, the user may supply the dynamic verification value 118 generated by the payment instrument service application 114 in place of the static verification value printed or otherwise physically presented on the payment instrument 112. During the instrument utilization, the third-party service 108 may transmit an authorization request to the payment instrument service 102 to determine whether the instrument utilization may be authorized and fulfilled. The authorization request from the third-party service 108 may include record data associated with the payment instrument 112 utilized by the user of the user device 110 for the instrument utilization (e.g., the UUID or other unique identifier corresponding to the payment instrument 112, the expiration date of the payment instrument 112, etc.), as well as the dynamic verification value 118 generated by the payment instrument service application 114 and supplied to the third-party service 108 by the user.

In an embodiment, the payment instrument service 102 implements a dynamic verification value evaluation microservice 104 that is configured to automatically, and in real-time or near real-time, evaluate any authorization requests submitted by different third-party services (including third-party service 108) as these authorization requests are received to determine whether any included dynamic verification values are valid. The dynamic verification value evaluation microservice 104 may comprise one or more computer systems of the payment instrument service 102 or may be implemented as an application or process executing on a computer system of the payment instrument service 102. In some instances, the dynamic verification value evaluation microservice 104 may be configured with various special-purpose components that can facilitate real-time or near real-time processing of different authorization requests from any number of different third-party services as these different authorization requests are received. Further, these various special-purpose components may be configured to automatically evaluate any included dynamic verification values for any number of different payment instruments to determine whether the dynamic verification values included in the different authorization requests are valid and, based on this determination, perform one or more actions (e.g., fulfill the authorization request, deny the authorization request, transmit the authorization request to another microservice implemented by the payment instrument service 102 for additional evaluation of the authorization request, etc.). Thus, the dynamic verification value evaluation microservice 104 can continuously and simultaneously process different authorization request messages from different third-party services and for different instrument utilizations associated with any number of users and payment instruments.

Returning to the illustrative example provided in FIG. 1, in response to an authorization request including the dynamic verification value associated with the payment instrument 112, the dynamic verification value evaluation microservice 104 may query the user records repository 106 to determine whether a secret code corresponding to the payment instrument 112 is maintained within the user record associated with the payment instrument 112. For instance, the dynamic verification value evaluation microservice 104 may use the UUID, portion of the UUID, an obfuscated portion of the UUID, or other unique identifier corresponding to the payment instrument 112 to query the user records repository 106 for a user record associated with the payment instrument 112. If the dynamic verification value evaluation microservice 104 is unable to identify a user record corresponding to the payment instrument 112 within the user records repository 106, the dynamic verification value evaluation microservice 104 may determine that the payment instrument 112 has not been enrolled for implementation of dynamic verification values. Accordingly, the dynamic verification value evaluation microservice 104 may be unable to validate the provided dynamic verification value provided in the authentication request. This may cause the dynamic verification value evaluation microservice 104 to perform a process corresponding to a missing valid dynamic verification value for the authorization request. For example, in some instances, the dynamic verification value evaluation microservice 104 may automatically reject the request. Alternatively, the dynamic verification value evaluation microservice 104 may transmit the authorization request to another microservice implemented by the payment instrument service 102 for further evaluation of the authorization request. For example, the dynamic verification value evaluation microservice 104 may transmit the authorization request to a fraud detection microservice (not shown), which may process the authorization request to determine whether the present instrument utilization is fraudulent or authentic. Based on this determination, the fraud detection microservice may determine whether to fulfill or deny the authorization request.

In some instances, if the payment instrument 112 has not been enrolled for implementation of dynamic verification values, the dynamic verification value evaluation microservice 104 may compare the dynamic verification value provided in the authorization request to the actual static verification value associated with the payment instrument 112 to determine whether the user has supplied the static verification value associated with the payment instrument 112. If the provided verification value matches the actual static verification value associated with the payment instrument 112, the dynamic verification value evaluation microservice 104 may perform a process corresponding to the presence of a valid verification value for the payment instrument referenced in the authorization request. For example, if the dynamic verification value evaluation microservice 104 determines that the authorization request includes a valid verification value associated with the payment instrument 112, the dynamic verification value evaluation microservice 104 may automatically fulfill the authorization request. Alternatively, in some instances, the dynamic verification value evaluation microservice 104 may transmit the authorization request to another microservice implemented by the payment instrument service 102 for further evaluation of the authorization request. This other microservice may include a fraud detection microservice (not shown), which may process the authorization request to determine whether the present instrument utilization is fraudulent or authentic. The other microservice may alternatively include an instrument utilization evaluation microservice (not shown), which may process the instrument utilization to determine whether the amount corresponding to the instrument utilization is available from the user's payment instrument account. Based on this determination, the instrument utilization evaluation microservice may determine whether to fulfill the authorization request.

In an embodiment, if the user record corresponding to the payment instrument 112 includes a secret code previously generated by the payment instrument service application 114, the dynamic verification value evaluation microservice 104 may process the secret code, a portion of the UUID or other unique identifier corresponding to the payment instrument 112, and the time interval corresponding to when the instrument utilization was generated as input to a hashing algorithm to generate a reference dynamic verification value for the payment instrument 112. The hashing algorithm used by the dynamic verification value evaluation microservice 104 may be the same hashing algorithm as that used by the payment instrument service application 114 implemented on the user device 110. Further, the portion of the UUID or other unique identifier corresponding to the payment instrument 112 used as input to the hashing algorithm may correspond to the same portion used by the payment instrument service application 114 to generate the dynamic verification value 118.

Once the dynamic verification value evaluation microservice 104 has generated a reference dynamic verification value for the payment instrument 112, the dynamic verification value evaluation microservice 104 may compare the dynamic verification value provided in the authorization request to this newly generated reference dynamic verification value. If the dynamic verification value evaluation microservice 104 determines that the dynamic verification value provided in the authorization request does not match the reference dynamic verification value, the dynamic verification value evaluation microservice 104 may determine whether the provided dynamic verification value matches the actual static verification value presented on the payment instrument 112. If the dynamic verification value provided in the authorization request does not match either the reference dynamic verification value or the static verification value for the payment instrument 112, the dynamic verification value evaluation microservice 104 may automatically perform a process corresponding to a missing valid dynamic verification value for the authorization request. This process, in some instances, may cause the dynamic verification value evaluation microservice 104 to automatically deny the authorization request. This may result in the instrument utilization being rejected by the payment instrument service 102 and the third-party service 108. Alternatively, this process may cause the dynamic verification value evaluation microservice 104 to transmit the authorization request to a fraud detection microservice (not shown), which may process the authorization request to determine whether the present instrument utilization is fraudulent or authentic, as described above. Thus, implementation of dynamic verification values may increase the network security of the payment instrument service 102, as the absence of a valid dynamic verification value for an authorization request may cause the payment instrument service 102 to reject this request and, thereby, prevent fraudulent use of the payment instrument 112. Further, the payment instrument service 102 may perform additional operations to prevent further use of the payment instrument 112, such as automatically rejecting any new authorization requests associated with the payment instrument 112 until one or more mitigating actions are performed by the holder of the payment instrument 112 (e.g., the holder contacts the payment instrument service 102 to request a replacement payment instrument, the holder verifies their identity and re-enrolls their payment instrument 112 for generation of dynamic verification values, etc.).

If the dynamic verification value provided in the authorization request matches the reference dynamic verification value generated by the dynamic verification value evaluation microservice 104, the dynamic verification value evaluation microservice 104 may execute a process corresponding to the successful validation of a provided dynamic verification value for a payment instrument 112. For example, in some instances, this process may cause the dynamic verification value evaluation microservice 104 to automatically fulfill the authorization request. To fulfill the authorization request, the dynamic verification value evaluation microservice 104 may transmit a response to the third-party service 108 indicating that the payment instrument 112 may be used for the present instrument utilization. Accordingly, the third-party service 108, in conjunction with the payment instrument service 102, may process the instrument utilization. In some instances, the process, when executed, may cause the dynamic verification value evaluation microservice to transmit the authorization request to another microservice implemented by the payment instrument service 102 for further evaluation of the authorization request. This other microservice may include a fraud detection microservice (not shown), which may process the authorization request to determine whether the present instrument utilization is fraudulent or authentic. The other microservice may alternatively include an instrument utilization evaluation microservice (not shown), which may process the instrument utilization to determine whether the amount corresponding to the instrument utilization is available from the user's payment instrument account. Based on the determinations of the fraud detection microservice and/or the instrument utilization evaluation microservice, the payment instrument service 102 may determine whether to fulfill the authorization request.

In an embodiment, when the dynamic verification value evaluation microservice 104 successfully validates a provided dynamic verification value for a payment instrument 112, the dynamic verification value evaluation microservice 104 automatically transmits a notification to the payment instrument service application 114 to indicate that this dynamic verification value can no longer be used for new transactions. As noted above, a dynamic verification value may be subject to an expiration time and date, after which the dynamic verification value is automatically expired. If this dynamic verification value is used successfully for an instrument utilization, the dynamic verification value evaluation microservice 104 may automatically reject any new transactions associated with this dynamic verification value. Thus, a user of the payment instrument 112 may need to wait for automatic generation of a new dynamic verification value at the end of the expiration time and date in order to use the payment instrument 112 for a new transaction. This may enhance the security of the payment instrument service 102 in various ways. For example, by limiting use of a particular dynamic verification value to a singular instrument utilization, an unauthorized user that gains access to the payment instrument 112 and the dynamic verification value may be prevented from using the payment instrument 112 any number of times for fraudulent transactions while dynamic verification value is active. This, in turn, may reduce the number of fraudulent transactions that are processed by the payment instrument service 102, as the dynamic verification value evaluation microservice 104 may automatically reject these fraudulent transactions before they are evaluated further by the payment instrument service 102.

In some instances, when the dynamic verification value evaluation microservice 104 successfully validates a provided dynamic verification value for a payment instrument 112, the dynamic verification value evaluation microservice 104 automatically transmit a set of executable instructions to the payment instrument service application 114 that, when executed, cause the payment instrument service application 114 to dynamically generate a new dynamic verification value for the payment instrument 112. This may cause the previously used dynamic verification value to be automatically expired and invalid for further use. Thus, if an unauthorized user gains access to the previously used dynamic verification value after it has been used for an instrument utilization, the unauthorized user is unable to use this previously used dynamic verification value for new instrument utilizations. This may further reduce the number of fraudulent transactions that may be processed by the payment instrument service 102, enhancing the network security of the payment instrument service 102.

It should be noted that, in some instances, the implementation of dynamic verification values may be exclusive to authorization requests corresponding to new instrument utilizations. For instance, dynamic verification values may not be valid for instrument utilization adjustments or refunds. Thus, if the dynamic verification value evaluation microservice 104 receives an authorization request corresponding to an instrument utilization adjustment or refund, the dynamic verification value evaluation microservice 104 may automatically reject the request.

FIG. 2 shows an illustrative example of an environment 200 in which a secret code is generated between a payment instrument service application 114 and a dynamic verification value code microservice 202 for generation of dynamic verification values in accordance with at least one embodiment. In the environment 200, a user of the user device 110, through the payment instrument service application 114, may submit a request to enroll a payment instrument 112 for generation of dynamic verification values that may be used as a substitute for the static verification value printed or otherwise presented on the user's payment instrument 112. When the user of the user device 110 accesses the payment instrument service application 114 for the first time, the payment instrument service application 114 may prompt the user to provide a set of credentials associated with a user record that may be maintained by the payment instrument service 102 through an authentication microservice (not shown) and that may be associated with one or more payment instruments issued by the payment instrument service 102 to the user. As noted above, if the user provides a set of credentials corresponding to their user record, the payment instrument service application 114, through an API exposed by the payment instrument service 102, may transmit a request to the authentication microservice to retrieve any record data associated with the user's payment instruments. If the authentication microservice successfully authenticates the provided set of credentials, the authentication microservice may retrieve any available record data from the user records repository 106 that is associated with the user and provide this record data to the payment instrument service application 114 for presentation to the user.

In an embodiment, once the user has been authenticated by the authentication microservice, the payment instrument service application 114 automatically interacts with the operating system and any peripheral devices of the user device 110 to determine whether the user device 110 supports wireless communications protocols for establishing wireless communications sessions. As noted above, if the payment instrument 112 is issued with an embedded RFID transponder or tag that automatically emits encoded record data associated with the payment instrument 112, the payment instrument service application 114 may automatically interact with the operating system and any peripheral devices of the user device 110 to determine whether the user device 110 implements any NFC protocols that may be used to detect, receive, and process such encoded record data emitted by the payment instrument 112 through the embedded RFID transponder or tag.

In some instances, the payment instrument service application 114 may prompt the user of the user device 110 to determine whether they would like to enroll their payment instrument 112 for generation of dynamic verification values that may be used in place of the static verification value printed or otherwise presented on their payment instrument 112. For example, the payment instrument service application 114 may present, through an instrument interface implemented by the payment instrument service application 114 (e.g., a graphical user interface (GUI)), an option for enrolling a corresponding payment instrument 112 for generation of dynamic verification values. This option may be presented in the form of a user interface button within the instrument interface. However, it should be noted that the option to enroll a payment instrument 112 for generation of dynamic verification values may be presented within the instrument interface using any available alternative user interface elements (e.g., sliders, hyperlinks, etc.). Further, the option may be presented in a format that prompts the user to provide a response through other forms of interaction with the user device 110 (e.g., voice response, gesture response, etc.).

In an embodiment, if the user device 110 supports NFC or other short-range wireless communications protocols through which record data from payment instruments may be obtained, the payment instrument service application 114 automatically enrolls the payment instruments (such as payment instrument 112) associated with the user for generation of dynamic verification values. This may obviate the need for the user to select an option for enrollment of their payment instrument 112 for generation of dynamic verification values. Alternatively, if the user device 110 does not support NFC or other short-range wireless communications protocols or these wireless communications protocols are otherwise disabled on the user device 110, the payment instrument service application 114 may automatically present the option to enroll the payment instrument 112 for generation of dynamic verification values, as described above.

If the payment instrument 112 is to be enrolled for generation of dynamic verification values (e.g., the user selects the presented option, the user device 110 supports NFC or other short-range wireless communications protocols, etc.), the payment instrument service application 114 dynamically generates a secret code that, along with record data associated with the payment instrument 112, may be used as input to a dynamic verification value generation algorithm 204 to generate dynamic verification codes for the payment instrument 112. In an embodiment, the secret code is generated by the payment instrument service application 114 using the dynamic verification value generation algorithm 204. As noted above, the secret code may be a UUID, GUID, or other statistically unique identifier that may serve as a verification value seed for the generation of dynamic verification values. Alternatively, in some instances, the secret code may be a shared secret established between the payment instrument service application 114 and the payment instrument service 102 through a secure communications channel and a symmetric-key algorithm, a Diffie-Hellman key exchange scheme, or any other suitable cryptographic method.

If the payment instrument service application 114 generates, through the dynamic verification value generation algorithm 204, a new secret code for the payment instrument 112, the payment instrument service application 114 may automatically transmit a request, through an API exposed by the payment instrument service 102, to a dynamic verification value code microservice 202 to associate the payment instrument 112 with this secret code within the user record corresponding to the user. This request (e.g., API call) may include any available record data associated with the payment instrument 112 (e.g., a UUID or other unique identifier corresponding to the payment instrument record associated with the payment instrument 112, a payment instrument record type, etc.) and the newly generated secret code. The dynamic verification value code microservice 202, in some instances, may comprise one or more computer systems of the payment instrument service 102 or may be implemented as an application or process executing on a computer system of the payment instrument service 102. In some instances, the dynamic verification value code microservice 202 may be configured with various special-purpose components that can facilitate real-time or near real-time processing of different enrollment requests from any number of different instances of the payment instrument service application 114 implemented on different user devices as these different enrollment requests are received. Further, these various special-purpose components may be configured to automatically evaluate any included secret codes for any number of different payment instruments to determine whether these different enrollment requests may be fulfilled or denied. Thus, the dynamic verification value code microservice 202 can continuously and simultaneously process different enrollment requests from different instances of the payment instrument service application 114 and for different payment instruments associated with any number of users.

In response to the request from the payment instrument service application 114, the dynamic verification value code microservice 202 may query the user records repository 106 to determine whether the user record associated with the particular payment instrument 112 is associated with an existing secret code previously generated for the payment instrument 112. For instance, using the record data provided in the request and corresponding to the payment instrument 112, the dynamic verification value code microservice 202 may evaluate the user record corresponding to the user to identify a payment instrument record corresponding to the payment instrument 112. The dynamic verification value code microservice 202 may evaluate this payment instrument record for the payment instrument 112 to determine whether the payment instrument record persists an existing secret code for generation of dynamic verification values for the payment instrument 112.

If the dynamic verification value code microservice 202 determines that the user record corresponding to the user and associated with the payment instrument 112 persists an existing secret code, the dynamic verification value code microservice 202 may return a failure code that serves as an indication that dynamic verification values cannot be generated for the payment instrument 112. The failure code may be indicative of a possible authentication issue related to the user whereby the payment instrument 112 may be registered to a different user device 110 and/or instance of the payment instrument service application 114. Accordingly, if the payment instrument service application 114 receives this failure code from the dynamic verification value code microservice 202, the payment instrument service application 114 may prompt the user to contact the payment instrument service 102 to address this possible user authentication issue and to remove the existing secret code from their user record. If the existing secret code is successfully removed from the user record, the dynamic verification value code microservice 202 may transmit a response to the payment instrument service application 114 to indicate that the payment instrument 112 may be enrolled for generation of dynamic verification values. This may cause the payment instrument service application 114 to present the user with the option to enroll the payment instrument 112 for generation of dynamic verification values, as described above.

If the user record does not persist an existing secret code for the payment instrument 112, the dynamic verification value code microservice 202 may store the unique identifier associated with the payment instrument 112 and the secret code in the user record within the user records repository 106. In some instances, the unique identifier associated with the payment instrument 112 may be obfuscated within the user records repository 106 to prevent inadvertent exposure of the unique identifier to unauthorized entities. Additionally, the dynamic verification value code microservice 202 may transmit a response that includes a success code or other indication that the payment instrument 112 is successfully enrolled for generation of dynamic verification values.

In response to this success code or other indication of successful enrollment of the payment instrument 112 for generation of dynamic verification values, the payment instrument service application 114, through the dynamic verification value generation algorithm 204, may begin generating dynamic verification values for the payment instrument 112. For instance, in response to the success code or other indication, the dynamic verification value generation algorithm 204 may dynamically process the secret code, at least a portion of the UUID or other unique identifier corresponding to the payment instrument 112 (e.g., the last four digits of the payment instrument number presented on the payment instrument 112, etc.), and data corresponding to a current time interval to generate a dynamic verification value for the payment instrument 112. The payment instrument service application 114 may present the newly generated dynamic verification value to the user for use in instrument utilizations.

In an embodiment, the dynamic verification value generation algorithm 204 is configured to generate dynamic verification values according to the format of the static verification value printed or otherwise presented on the payment instrument 112. For instance, if the payment instrument service 102 implements, for the payment instrument 112, a three-digit static verification value, the dynamic verification value generation algorithm 204 may be configured to also generate three-digit dynamic verification values for the payment instrument 112. Similarly, if the payment instrument service 102 implements, for the payment instrument 112, a four-digit static verification value, the dynamic verification value generation algorithm 204 may be configured to also generate four-digit dynamic verification values for the payment instrument 112. In an embodiment, when the payment instrument service application 114 receives record data from the payment instrument 112 through the NFC or other short-range communications protocol, the payment instrument service application 114 processes the record data to determine the format of the static verification value implemented on the payment instrument 112. Based on this evaluation, the payment instrument service application 114 may automatically configure the dynamic verification value generation algorithm 204 to generate dynamic verification values for the payment instrument 112 according to the identified format. In some instances, the identified format may be used as input to the dynamic verification value generation algorithm 204 for generation of the dynamic verification values for the payment instrument 112.

As noted above, the dynamic verification values generated by the payment instrument service application 114 may be valid for a limited period of time, after which these dynamic verification values may be automatically expired and rotated for new dynamic verification values. For instance, as noted above, for a particular dynamic verification value generated by the dynamic verification value generation algorithm 204, the payment instrument service application 114 may indicate the expiration time and date for this dynamic verification value. In an embodiment, if the payment instrument service application 114 detects that a dynamic verification value is expired, the payment instrument service application 114 may automatically, and in real-time, execute the dynamic verification value generation algorithm 204 to automatically generate a new dynamic verification value for the payment instrument 112. For instance, at the conclusion of a particular time interval (e.g., the time at which a present dynamic verification value is to expire), the dynamic verification value generation algorithm 204 automatically processes the secret code, the portion of the UUID or other unique identifier corresponding to the payment instrument 112, and the new time interval to generate a new dynamic verification value 118. Accordingly, the payment instrument service application 114 may present, through the instrument interface, this new dynamic verification value in place of the expired dynamic verification value.

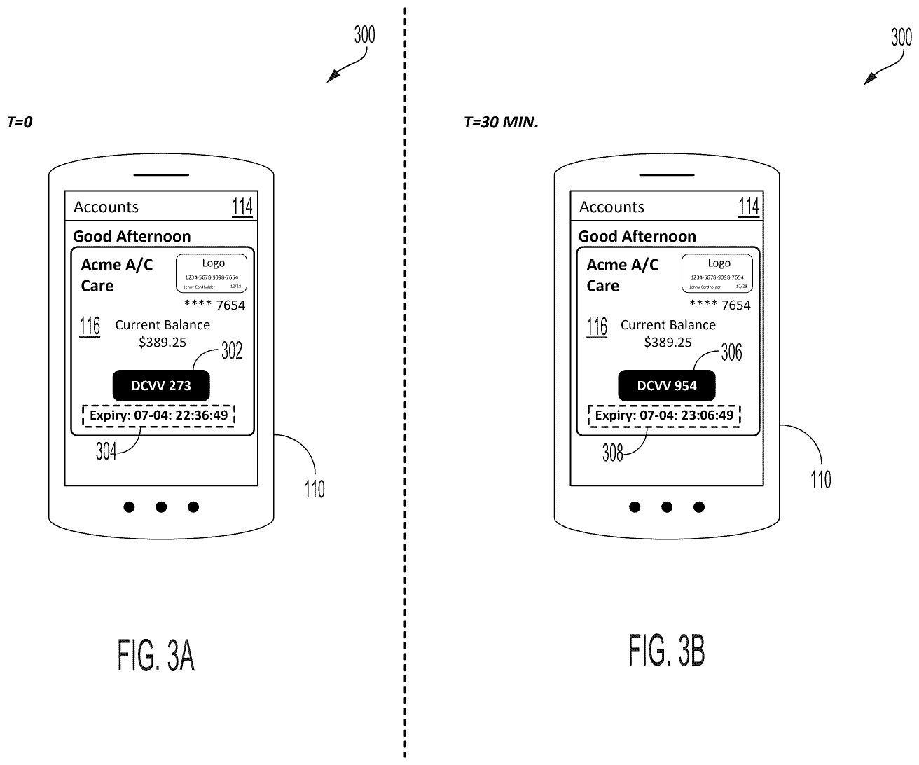

FIGS. 3A-3B show an illustrative example of an environment 300 in which dynamic verification values for a payment instrument are automatically updated at pre-defined time intervals in accordance with at least one embodiment. In the environment 300, and as illustrated in FIG. 3A, the payment instrument service application 114 executed on the user device 110 may provide, through an instrument interface 116, an initial dynamic verification value 302 for a particular payment instrument. As noted above, when a user initially enrolls their payment instrument for generation of dynamic verification values, the payment instrument service application 114, through the aforementioned dynamic verification value generation algorithm, may dynamically generate a secret code that may serve as a seed for generating dynamic verification values for the payment instrument. The payment instrument service application 114 may use the secret code, at least a portion of the UUID or other unique identifier corresponding to the payment instrument (e.g., the last four digits of the payment instrument number presented on the payment instrument, etc.), and data corresponding to a current time interval as input to the dynamic verification value generation algorithm to generate the initial dynamic verification value 302 for the payment instrument.

As illustrated in FIG. 3A, the initial dynamic verification value 302 (i.e., “273”) may be presented through the instrument interface 116 with an expiration date 304 for the initial dynamic verification value 302. This expiration date 304 may be identified according to a pre-defined time interval after which the dynamic verification value 302 is automatically expired and generation of a new dynamic verification value is required. For instance, when the enrollment request for the payment instrument is fulfilled by the dynamic verification value code microservice of the payment instrument service, the dynamic verification value code microservice may transmit to the payment instrument service application 114, the time interval for each dynamic verification value that is to be generated for the payment instrument. Further, the dynamic verification value code microservice may obtain data corresponding to the actual time at which the initial dynamic verification value 302 is generated for the payment instrument. This data may be used to synchronize the payment instrument service application 114 and the dynamic verification value code microservice to allow precise identification of time intervals for dynamic verification values that are to be generated for the payment instrument. This further allows for authentication of any dynamic verification values associated with the payment instrument as the time intervals and corresponding generation and expiration times for each dynamic verification value may be synchronized between the payment instrument service application 114 and the payment instrument service.

As illustrated in FIG. 3A, the expiration date 304 for the initial dynamic verification value 302 is set for July 4^{th} at 10:36:49 P.M. (i.e., 22:36:49 in 24-hour notation). This expiration date 304 may represent the sum of the time at which the initial dynamic verification value 302 was generated and the pre-defined time interval that is used to determine the longevity of each dynamic verification value for the payment instrument. As an illustrative example, if the pre-defined time interval is thirty minutes, and the initial dynamic verification value 302 is generated on July 4^{th} at 10:06:49 P.M. (i.e., 22:06:49 in 24-hour notation), the payment instrument service application may determine that the initial dynamic verification value 302 is set to automatically expire thirty minutes from this time, i.e., July 4^{th} at 10:36:49 P.M. (i.e., 22:36:49 in 24-hour notation). Thus, the payment instrument service application 114 may update the instrument interface 116 to present the initial expiration date 304 for the initial dynamic verification value 302.

In an embodiment, at the end of the pre-defined time interval for the initial dynamic verification value 302 (e.g., at T=30 minutes from the time at which the initial dynamic verification value 302 was generated), the payment instrument service application 114 may automatically determine that the initial dynamic verification value 302 is expired. Upon detecting that the initial dynamic verification value 302 is expired, the payment instrument service application 114 may automatically determine whether the secret code for generating the dynamic verification value for the payment instrument is available. If the payment instrument service application 114 determines that the secret code is not available (e.g., is not stored within a repository or other record within the user device 110), the payment instrument service application 114 may automatically generate a new secret code for the payment instrument and transmit a request to the payment instrument service to associate the secret code with the payment instrument (i.e., enroll the payment instrument for generation of dynamic verification values, as described above in connection with FIG. 2).

If the payment instrument service application 114 identifies an existing secret code associated with the payment instrument or otherwise generates a secret code that is accepted by the payment instrument service, the payment instrument service application 114 may process the secret code, the portion of the UUID or other unique identifier corresponding to the payment instrument previously used to generate the initial dynamic verification value 302, and data corresponding to the new time interval through the dynamic verification value generation algorithm to generate a new dynamic verification value 306 for the payment instrument. As illustrated in FIG. 3B, the payment instrument service application 114 may dynamically update the instrument interface 116 to replace the now expired initial dynamic verification value 302 with the newly generated dynamic verification value 306. Additionally, through the instrument interface 116, the payment instrument service application 114 may provide an updated expiration date 308 for the newly generated dynamic verification value 306. The updated expiration date 308 (as with the expiration date 304 for the initial dynamic verification value 302) may represent the sum of the time at which the updated dynamic verification value 306 was generated and the pre-defined time interval that is used to determine the longevity of each dynamic verification value for the payment instrument. Returning to the illustrative example provided in FIG. 3B, the expiration date 308 for the newly generated dynamic verification value 306 is July 4^{th} at 11:06:49 P.M. (i.e., 23:06:49 in 24-hour notation), which is exactly thirty minutes from the expiration date 304 of the initial dynamic verification value 302 and the time at which the new dynamic verification value 306 was generated. Thus, as the payment instrument service application 114 dynamically generates, through the dynamic verification value generation algorithm, new dynamic verification values for the payment instrument, the payment instrument service application 114 may dynamically, and in real-time, update the instrument interface 116 to present these new dynamic verification values and corresponding expiration dates to the user of the user device 110.

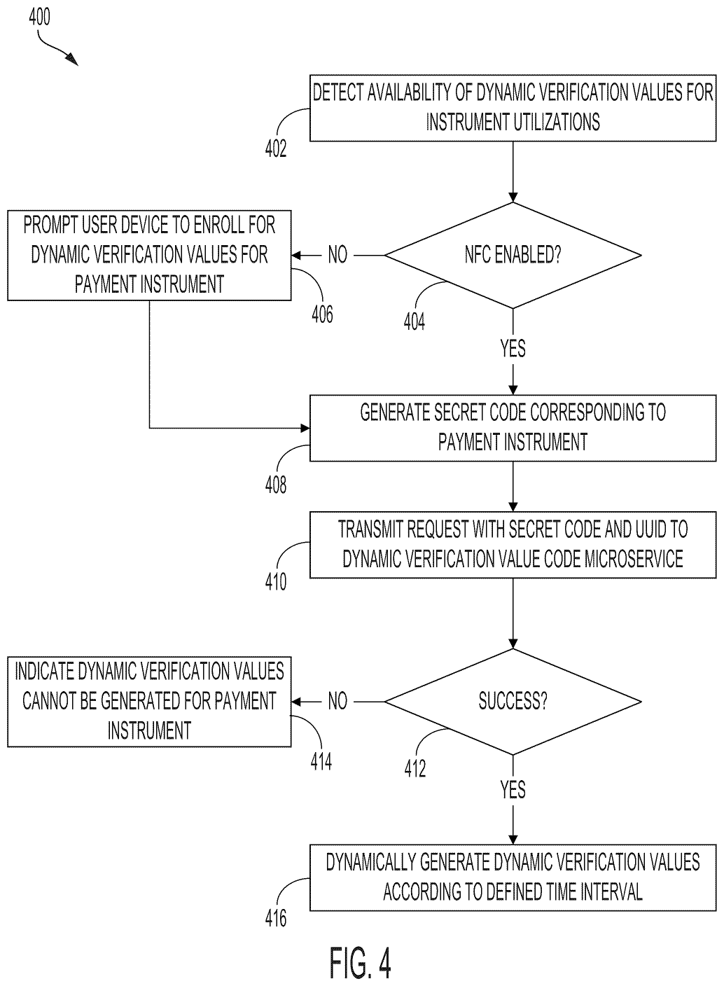

FIG. 4 shows an illustrative example of a process 400 for dynamically generating dynamic verification values for a payment instrument in accordance with at least one embodiment. The process 400 may be performed by a payment instrument service application executing on a user device. Further, the payment instrument service application may be configured to interact with one or more peripheral devices of the user device to obtain record data corresponding to different payment instruments. Additionally, the payment instrument service application may be configured to transmit requests to the payment instrument service through one or more APIs exposed by the payment instrument service, as described in greater detail herein.

At step 402, the payment instrument service application may detect the availability of operations for generating dynamic verification values for one or more payment instruments associated with a user. For instance, when a user accesses the payment instrument service application for the first time or the user is otherwise not logged into their user record maintained by the payment instrument service, the payment instrument service application may prompt the user to provide a set of credentials that may be used to authenticate the user and determine whether the user is authorized to access their user record. The payment instrument service application, through an API exposed by the payment instrument service, may transmit a request (i.e., an API call) to the aforementioned authentication microservice implemented by the payment instrument service to retrieve any record data associated with the user's payment instruments. This request may include any provided set of credentials and identifying information associated with the user.

If the authentication microservice successfully authenticates the user, the authentication microservice may retrieve any available record data corresponding to the user's payment instruments and provides the record data to the payment instrument service application for presentation to the user. The record data for each payment instrument may include balance information corresponding to the payment instrument. Further, the record data may include additional information associated with the payment instrument that may be useful to the user (e.g., available credit amount, remaining credit amount, most recent payment information, etc.). In an embodiment, the authentication microservice may query the dynamic verification value code microservice to determine whether dynamic verification values may be generated for the payment instrument. If the dynamic verification value code microservice determines that dynamic verification values may be generated for the payment instrument (e.g., the dynamic verification value code microservice determines that the payment instrument is not associated with an existing secret code, etc.), the dynamic verification value code microservice may transmit a response to the authentication microservice to indicate that the payment instrument is eligible for generation of dynamic verification values. If the payment instrument is eligible for generation of dynamic verification values, the authentication microservice may update the record data associated with the payment instrument to include an indication of such eligibility. This indication may be automatically added to the record data by the authentication microservice as the corresponding functionality for generating dynamic verification values is implemented for different payment instruments. Thus, through review of the record data obtained from the authentication microservice, the payment instrument service application may automatically detect the availability of this functionality for the user's payment instruments and corresponding instrument utilizations.

At step 404, the payment instrument service application may determine whether the user device through which the payment instrument service application is executed has enabled NFC protocol functionality. For instance, the payment instrument service application may automatically interact with the operating system and any peripheral devices of the user device to determine whether the user device supports wireless communications protocols for establishing wireless communications sessions. As noted above, if the payment instrument implements an RFID transponder or tag that automatically emits encoded data, the payment instrument service application may automatically interact with the operating system and any peripheral devices of the user device to determine whether the user device implements any NFC protocols that may be used to detect, receive, and process such encoded data emitted by the payment instrument through the RFID transponder or tag.

If the payment instrument service application determines that the user device does not support any NFC protocols or otherwise does not have enable NFC functionalities, the payment instrument service application, at step 406, may prompt the user of the user device to enroll for generation of dynamic verification values for their payment instrument. For instance, the payment instrument service application may update an instrument interface corresponding to the payment instrument to present the user with an option to enroll the payment instrument for generation of dynamic verification values. As noted above, this option may be presented in the form of a user interface button within the instrument interface. However, the option to enroll a payment instrument for generation of dynamic verification values may be presented within the instrument interface using any available alternative user interface elements (e.g., sliders, hyperlinks, etc.). Further, the option may be presented in a format that prompts the user to provide a response through other forms of interaction with the user device (e.g., voice response, gesture response, etc.).

If the user device supports and has enabled NFC functionalities, or the user has selected an option to enroll their payment instrument for generation of dynamic verification values, the payment instrument service application, at step 408, may dynamically generate a secret code corresponding to the payment instrument. As noted above, in some instances, the secret code may be generated by the payment instrument service application using a dynamic verification value generation algorithm implemented by the payment instrument service application on the user device. Alternatively, the secret code may be a shared secret established between the payment instrument service application and the payment instrument service through a secure communications channel and a symmetric-key algorithm, a Diffie-Hellman key exchange scheme, or any other suitable cryptographic method. The secret code, in some instances, may be a UUID, GUID, or other statistically unique identifier that may serve as a verification value seed for the generation of dynamic verification values.

At step 410, the payment instrument service application may transmit a request including the secret code and the unique identifier corresponding to the payment instrument (e.g., UUID, GUID, record number, etc.) to the dynamic verification value code microservice of the payment instrument service. This request may be transmitted to the dynamic verification value code microservice through an exposed API implemented by the payment instrument service. In response to the request from the payment instrument service application, the dynamic verification value code microservice may query a user records repository maintained by the payment instrument service to determine whether the user record associated with the particular payment instrument is associated with an existing secret code previously generated for the payment instrument. If the dynamic verification value code microservice determines that the user record corresponding to the user and associated with the payment instrument persists an existing secret code, the dynamic verification value code microservice may return a failure code that serves as an indication that dynamic verification values cannot be generated for the payment instrument. Alternatively, if the user record does not persist an existing secret code for the payment instrument, the dynamic verification value code microservice may store the unique identifier associated with the payment instrument and the secret code in the user record. Additionally, the dynamic verification value code microservice may transmit a response that includes a success code or other indication that the payment instrument is successfully enrolled for generation of dynamic verification values.

Based on the response obtained from the dynamic verification value code microservice, the payment instrument service application, at step 412, may determine whether the secret code was successfully accepted by the dynamic verification value code microservice and accordingly associated with the payment instrument. If the payment instrument service application receives a failure code from the dynamic verification value code microservice indicating that the secret code was not accepted by the dynamic verification value code microservice, the payment instrument service application, at step 414, may indicate that dynamic verification values cannot be generated for the payment instrument. In such instances, the payment instrument service application may prompt the user to contact the payment instrument service to address a possible user authentication issue and to remove the existing secret code from their user record. If the existing secret code is successfully removed from the user record, the dynamic verification value code microservice may transmit a response to the payment instrument service application to indicate that the payment instrument may be enrolled for generation of dynamic verification values. This may cause the payment instrument service application to present the user with the option to enroll the payment instrument for generation of dynamic verification values, as described above.

If the payment instrument service application receives a success code from the dynamic verification value code microservice indicating that the secret code was accepted by the dynamic verification value code microservice, the payment instrument service application, at step 416, may begin to dynamic generate dynamic verification values for the payment instrument according to the pre-defined time interval. For instance, in response to the success code or other indication, the dynamic verification value generation algorithm 204 may dynamically process the secret code from the dynamic verification value code microservice, the payment instrument service application may use the secret code, at least a portion of the UUID or other unique identifier corresponding to the payment instrument (e.g., the last four digits of the payment instrument number presented on the payment instrument, etc.), and data corresponding to a current time interval to generate a dynamic verification value for the payment instrument. The payment instrument service application may present the newly generated dynamic verification value to the user for use in instrument utilizations.

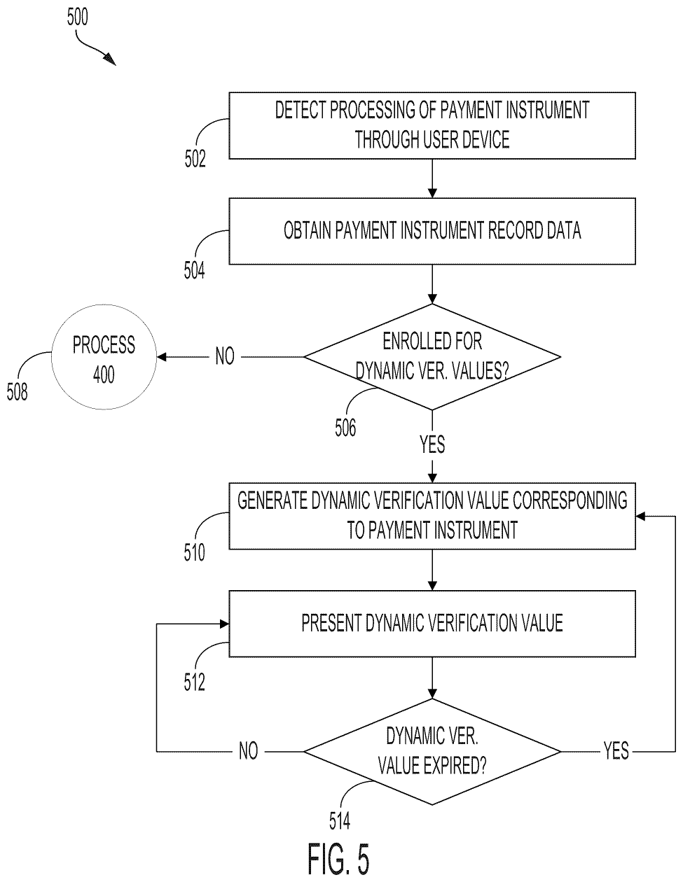

FIG. 5 shows an illustrative example of a process 500 for generating and presenting a dynamic verification value associated with a payment instrument for an instrument utilization in accordance with at least one embodiment. The process 500 may be performed by the payment instrument service application implemented on a user device through which a user may process an existing payment instrument for instrument utilizations. In some instances, certain steps of the process 500 may be performed through a dynamic verification value generation algorithm implemented by the payment instrument service application. Additionally, the process 500 may be performed post-enrollment of a payment instrument for generation of dynamic verification values.

At step 502, the payment instrument service application may detect processing of a payment instrument through the user device. As noted above, if the user device supports NFC or other short-range wireless communications protocols, the payment instrument service application may be able to detect and receive short-range RFID signals emitted by the payment instrument when the payment instrument is placed within a configured distance from the user device. Accordingly, in some instances, a user of the payment instrument may tap or otherwise bring their payment instrument within proximity of the user device to enable detection of short-range RFID signals emitted by an RFID transponder or tag embedded in the payment instrument. If the user device detects short-range RFID signals emitted by the RFID transponder or tag embedded in the payment instrument, the user device may automatically execute the payment instrument service application.

In an embodiment, once the user device executes the payment instrument service application, the payment instrument service application may determine whether the user is logged on to their user record. As noted above, in order to access their user record, a user may be required to provide a set of credentials that may be used by the authentication microservice to authenticate the user. If the user's existing session with the payment instrument service through the payment instrument service application is still active, the user may not be required to provide their set of credentials for authentication of the user. However, if their session with the payment instrument service has expired, the payment instrument service application may prompt the user to provide their set of credentials for authentication of the user. If the user is successfully authenticated or is otherwise logged into their user record, the payment instrument service application may provide, through an instrument interface, any balance information corresponding to each payment instrument associated with the user and issued by the payment instrument service.

At step 504, the payment instrument service application may obtain record data corresponding to the payment instrument detected through the NFC or other short-range wireless communications protocol. For instance, in response to receiving a short-range RFID signal through the NFC protocol, the payment instrument service application may automatically, and in real-time or near real-time, verify that the payment instrument is associated with an existing user record maintained by the payment instrument service. For instance, if the user of the user device has been authenticated by the authentication microservice through the payment instrument service application, the payment instrument service application may compare the record data obtained from the payment instrument through the NFC protocol to the record data obtained from the authentication microservice and associated with the user's known payment instruments. If the payment instrument service application determines that the record data from the payment instrument is not associated with the record data obtained from the authentication microservice, the payment instrument service application may automatically transmit the record data obtained from the payment instrument to the authentication microservice for authentication. If the authentication microservice is unable to authenticate the record data obtained from the payment instrument through the NFC protocol, the authentication microservice may return an indication that authentication of the payment instrument has failed. Accordingly, the payment instrument service application may update the instrument interface to indicate that enrollment for dynamic verification values has failed and that the user is to contact the payment instrument service to address this authentication failure.

If the payment instrument service application determines that the record data obtained from the payment instrument according to the NFC or other short-range communications protocol is authentic (e.g., the record data corresponds to an existing payment instrument associated with a user record, etc.), the payment instrument service application, at step 506, may determine whether the payment instrument is enrolled for generation of dynamic verification values that may be used in place of the static verification value printed or otherwise presented on the payment instrument. For instance, the payment instrument service application may use the obtained record data associated with the payment instrument to determine whether the payment instrument is associated with an existing secret code usable to generate dynamic verification values for the payment instrument. As noted above, the payment instrument service application may store or otherwise persist secret codes corresponding to different payment instruments that have been enrolled for generation of dynamic verification values. These secret codes may be associated with corresponding record data associated with these different payment instruments and maintained by the payment instrument service for use by the dynamic verification value code microservice and the dynamic verification value evaluation microservice. Accordingly, the payment instrument service application may use the record data corresponding to the payment instrument to determine whether the payment instrument service application maintains a secret code for the payment instrument.

If the payment instrument service application determines that a secret code is not available for the payment instrument, the payment instrument service application may determine that the payment instrument is not enrolled for generation of dynamic verification values. Accordingly, the payment instrument service application, at step 508, may execute the process 400 described above in connection with FIG. 4 to allow for enrollment of the payment instrument for generation of dynamic verification values. Once the payment instrument has been enrolled for generation of dynamic verification values, the payment instrument service application may continue to perform the process 500 for this particular payment instrument.

If the payment instrument is enrolled for generation of dynamic verification values, the payment instrument service application, at step 510, may generate a new dynamic verification value corresponding to the payment instrument. As noted above, the payment instrument service application may use the secret code associated with the payment instrument, at least a portion of the UUID or other unique identifier corresponding to the payment instrument (e.g., the last four digits of the payment instrument number presented on the payment instrument, etc.), and data corresponding to a current time interval as input to the dynamic verification value generation algorithm to generate a dynamic verification value for the payment instrument.

The payment instrument service application, at step 512, may present the newly generated dynamic verification value to the user for use in instrument utilizations. For instance, the payment instrument service application may dynamically update an instrument interface corresponding to the payment instrument and displayed through the user device to present the newly generated dynamic verification value. This may allow the user to utilize the dynamic verification value for any instrument utilizations that require input of a verification value corresponding to the payment instrument.

As noted above, each dynamic verification value may be valid for a limited period of time after which the dynamic verification value is automatically expired. This limited period of time may be defined by the payment instrument service when enrolling the payment instrument for generation of dynamic verification values. Thus, the payment instrument service application, at step 514, may continually determine whether the presented dynamic verification value is expired. If the payment instrument service application detects that a dynamic verification value is expired, the payment instrument service application may return to step 510 and automatically, and in real-time, execute the dynamic verification value generation algorithm to generate a new dynamic verification value for the payment instrument. For instance, at the conclusion of a particular time interval (e.g., the time at which a present dynamic verification value is to expire), the dynamic verification value generation algorithm automatically processes the secret code, the portion of the UUID or other unique identifier corresponding to the payment instrument, and the new time interval to generate a new dynamic verification value. Accordingly, the payment instrument service application, at step 512, may present, through the instrument interface, this new dynamic verification value in place of the expired dynamic verification value. If the dynamic verification value is not expired, the payment instrument service application may continually repeat step 512 until it detects that the dynamic verification value is expired.

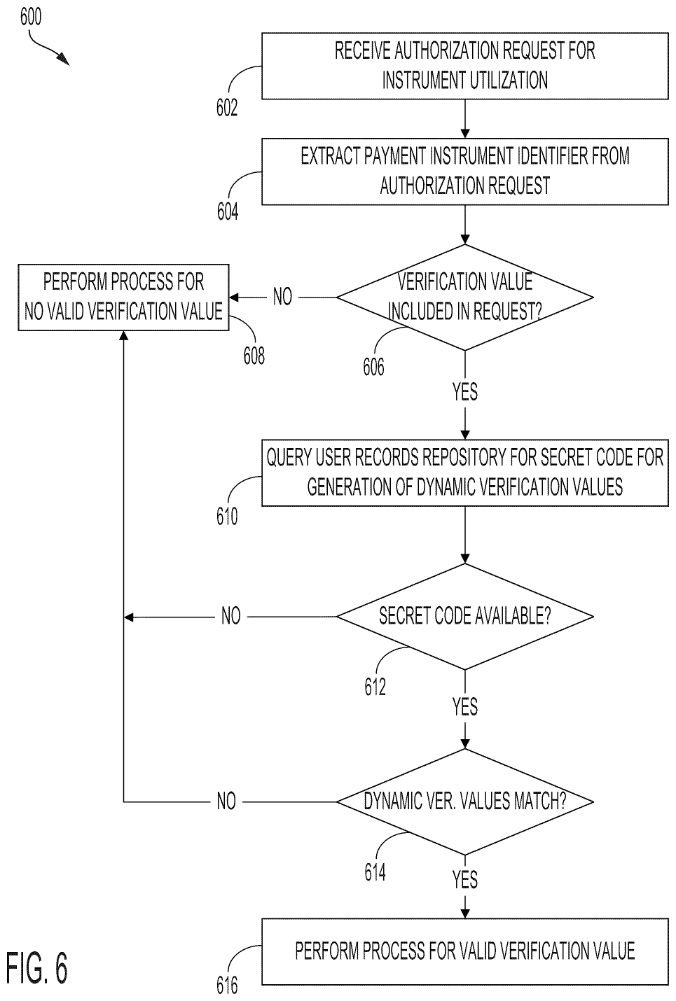

FIG. 6 shows an illustrative example of a process 600 for evaluating an authorization request associated with a payment instrument and including a dynamic verification value to determine whether to fulfill the authorization request in accordance with at least one embodiment. The process 600 may be performed by the payment instrument service through the dynamic verification value authentication microservice, as described above in connection with FIG. 1.

At step 602, the payment instrument service may receive an authorization request corresponding to a present instrument utilization associated with a particular payment instrument. As noted above, if the holder of the payment instrument engages in an instrument utilization with a third-party service and the third-party service requests a verification value associated with the payment instrument, the user may supply the dynamic verification value generated by the payment instrument service application in place of the static verification value printed or otherwise presented on the payment instrument. During the instrument utilization, the third-party service may transmit an authorization request to the payment instrument service to determine whether the instrument utilization may be authorized and fulfilled. The authorization request from the third-party service may include record data associated with the payment instrument used for the instrument utilization (e.g., the UUID or other unique identifier corresponding to the payment instrument, the expiration date of the payment instrument, etc.), as well as the dynamic verification value generated by the payment instrument service application and supplied to the third-party service by the holder of the payment instrument.

At step 604, the payment instrument service, through the dynamic verification value evaluation microservice, may process the received authorization request to extract the payment instrument identifier from the authentication request. This payment instrument identifier may include the UUID or other unique identifier corresponding to the payment instrument, as generated by the payment instrument service during issuance of the payment instrument. Additionally, at step 606, the dynamic verification value evaluation microservice may process the received authorization request to determine whether the authorization request includes a verification value that may be used to authenticate the payment instrument and, accordingly, determine whether the authorization request may be processed for possible fulfillment.

If the authorization request submitted by a third-party service does not include a verification value that may be used to authenticate the payment instrument being used for the instrument utilization, the dynamic verification value evaluation microservice, at step 608, may perform a process corresponding to the lack of a valid verification value associated with the payment instrument. In an embodiment, this process can include performing more stringent evaluation of the authorization request to determine whether the authorization request can be fulfilled. For instance, in some examples, the dynamic verification value evaluation microservice may outright reject the authorization request if it is devoid of a verification value corresponding to the payment instrument. In these examples, the dynamic verification value evaluation microservice may return a response to the third-party service to indicate that the authorization request could not be fulfilled as a result of the authorization request being devoid of a verification value associated with the payment instrument. Accordingly, the third-party service may terminate the instrument utilization. In some instances, the third-party service may prompt the holder of the payment instrument to supply a verification value for the payment instrument being used for the instrument utilization. If the holder of the payment instrument submits a verification value for the payment instrument, the third-party service may submit a new authorization request for the instrument utilization, thereby restarting the process 600. In some instances, rather than outright rejecting the authorization request, the dynamic verification value evaluation microservice may provide the authorization request to a fraud detection microservice implemented by the payment instrument service for further evaluation. The fraud detection microservice, in response to receiving the authorization request, may process the authorization request to determine whether the present instrument utilization is fraudulent or authentic. Based on this determination, the fraud detection microservice may determine whether to fulfill or deny the authorization request.

If the dynamic verification value evaluation microservice determines that the authorization request includes a verification value associated with the payment instrument being used for the instrument utilization, the dynamic verification value authentication microservice implemented by the payment instrument service, at step 610, may query the user records repository maintained by the payment instrument service for a secret code used to generate dynamic verification values for the payment instrument. Through this query of the user records repository, the dynamic verification value authentication microservice, at step 612, may determine whether a secret code corresponding to the payment instrument is available. As noted above, the dynamic verification value authentication microservice may use the unique identifier corresponding to the payment instrument referenced in the authorization request to query the user records repository for a user record associated with the payment instrument generated for the maintenance of secret codes.

If the dynamic verification value evaluation microservice is unable to identify a user record corresponding to the payment instrument within the user records repository, the dynamic verification value evaluation microservice may determine that the payment instrument has not been enrolled for implementation of dynamic verification values. Accordingly, the dynamic verification value evaluation microservice may be unable to verify the authenticity of the provided dynamic verification value provided in the authentication request. This may cause the dynamic verification value evaluation microservice, at step 608, to perform the aforementioned process corresponding to the absence of a valid verification value for the payment instrument. For example, in some instances, the absence of a secret code may cause the dynamic verification value evaluation microservice to automatically reject the authorization request. In some instances, if the payment instrument has not been enrolled for implementation of dynamic verification values, the dynamic verification value evaluation microservice may compare the dynamic verification value provided in the authorization request to the actual static verification value associated with the payment instrument to determine whether the user has supplied the static verification value associated with the payment instrument. If the provided verification value matches the actual static verification value associated with the payment instrument, the dynamic verification value evaluation microservice may perform a process corresponding to the presence of a valid verification value, as described in greater detail herein.

If the dynamic verification value evaluation microservice determines that a secret code corresponding to the payment instrument is available, the dynamic verification value evaluation microservice, at step 614, may determine whether the verification value included in the authorization request matches a reference dynamic verification value for the payment instrument. For instance, as noted above, the dynamic verification value evaluation microservice may process the secret code, a portion of the unique identifier corresponding to the payment instrument, and the time interval corresponding to when the instrument utilization was generated as input to a dynamic verification value generation algorithm to generate a reference dynamic verification value for the payment instrument. The dynamic verification value generation algorithm used by the dynamic verification value evaluation microservice may be the same dynamic verification value generation algorithm as that used by the payment instrument service application for generating dynamic verification values associated with the payment instrument. Further, the portion of the unique identifier corresponding to the payment instrument used as input to the dynamic verification value generation algorithm may correspond to the same portion used by the payment instrument service application to generate the dynamic verification value for the payment instrument.

As noted above, once the dynamic verification value evaluation microservice has generated a reference dynamic verification value for the payment instrument, the dynamic verification value evaluation microservice may compare the verification value provided in the authorization request to this newly generated reference dynamic verification value. If the dynamic verification value evaluation microservice determines that the verification value provided in the authorization request does not match the reference dynamic verification value, the dynamic verification value evaluation microservice may perform the aforementioned process corresponding to the absence of a valid verification value at step 608. In some instances, if the dynamic verification value evaluation microservice determines that the verification value provided in the authorization request does not match the reference dynamic verification value, before performing this process at step 608, the dynamic verification value evaluation microservice may determine whether the provided verification value matches the actual static verification value presented on the payment instrument. If the verification value provided in the authorization request does not match either the reference dynamic verification value or the static verification value for the payment instrument, the dynamic verification value evaluation microservice may automatically perform the aforementioned process corresponding to the absence of a valid verification value at step 608.

As noted above, if the verification value provided in the authorization request matches the reference dynamic verification value generated by the dynamic verification value evaluation microservice, the dynamic verification value evaluation microservice, at step 616, may perform a process corresponding to the presence of a valid verification value for the payment instrument. For instance, in some examples, the process may include fulfilling the authorization request. In these examples, the dynamic verification value evaluation microservice may transmit a response to the third-party service indicating that the payment instrument may be used for the present instrument utilization. Accordingly, the third-party service, in conjunction with the payment instrument service, may process the instrument utilization.

In some instances, rather than automatically fulfilling the authorization request if the authorization request includes a valid verification value for the payment instrument, the payment instrument service may process the authorization request through a fraud detection microservice. The fraud detection microservice may process the authorization request to determine, based on a set of characteristics associated with the present instrument utilization, whether the present instrument utilization is fraudulent or authentic. Additionally, or alternatively, the payment instrument service may process the authorization request through an instrument utilization evaluation microservice, which may process the instrument utilization to determine whether the amount corresponding to the instrument utilization is available from the user's payment instrument account. For example, if the instrument utilization has an associated value of $1,000, but the payment instrument can only support $500, the instrument utilization evaluation microservice may determine that the authorization request cannot be fulfilled. Based on the determinations of the fraud detection microservice and/or the instrument utilization evaluation microservice, the payment instrument service may determine whether to fulfill the authorization request and complete the process at step 616 for the present authorization request.

It should be noted that the process 600 may be performed in real-time or near real-time, to evaluate any authorization requests submitted by different third-party services as these authorization requests are received to determine whether any included dynamic verification values are valid. As noted above, the dynamic verification value evaluation microservice is configured to facilitate real-time or near real-time processing of different authorization requests from any number of different third-party services as these different authorization requests are received. Further, the dynamic verification value evaluation microservice is configured to automatically evaluate any included dynamic verification values for any number of different payment instruments to determine whether these different authorization requests may be fulfilled or denied. Thus, the dynamic verification value evaluation microservice can continuously and simultaneously process different authorization request messages from different third-party services and for different instrument utilizations associated with any number of users and payment instruments.

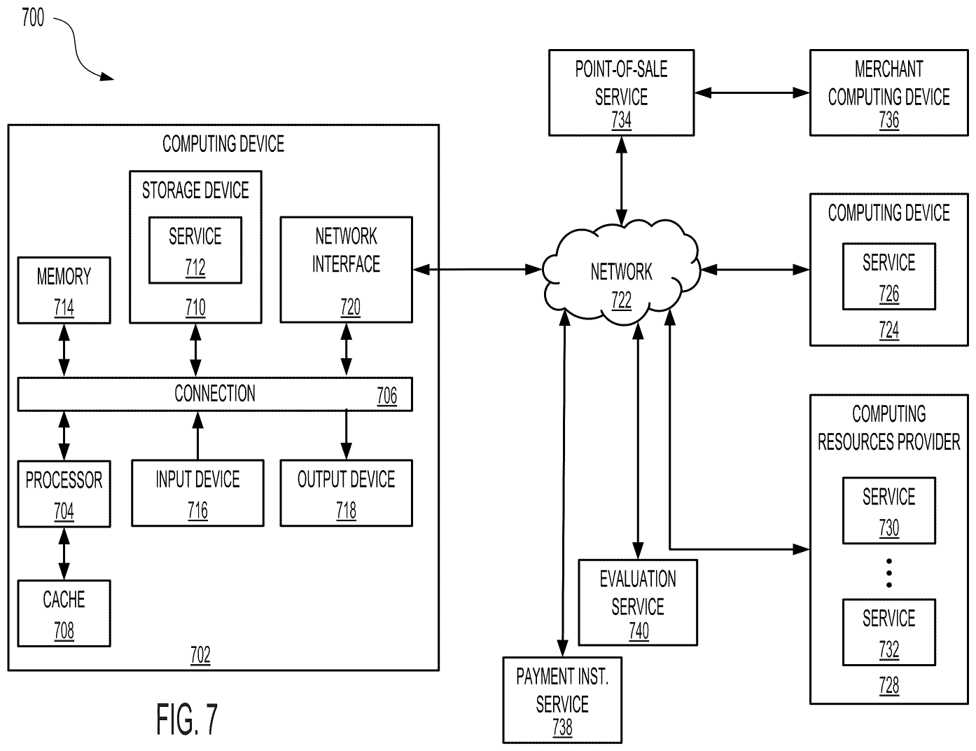

FIG. 7 illustrates a computing system architecture 700, including various components in electrical communication with each other, in accordance with some embodiments. The example computing system architecture 700 illustrated in FIG. 7 includes a computing device 702, which has various components in electrical communication with each other using a connection 706, such as a bus, in accordance with some implementations. The example computing system architecture 700 includes a processing unit 704 that is in electrical communication with various system components, using the connection 706, and including the system memory 714. In some embodiments, the system memory 714 includes read-only memory (ROM), random-access memory (RAM), and other such memory technologies including, but not limited to, those described herein. In some embodiments, the example computing system architecture 700 includes a cache 708 of high-speed memory connected directly with, in close proximity to, or integrated as part of the processor 704. The system architecture 700 can copy data from the memory 714 and/or the storage device 710 to the cache 708 for quick access by the processor 704. In this way, the cache 708 can provide a performance boost that decreases or eliminates processor delays in the processor 704 due to waiting for data. Using modules, methods and services such as those described herein, the processor 704 can be configured to perform various actions. In some embodiments, the cache 708 may include multiple types of cache including, for example, level one (L1) and level two (L2) cache. The memory 714 may be referred to herein as system memory or computer system memory. The memory 714 may include, at various times, elements of an operating system, one or more applications, data associated with the operating system or the one or more applications, or other such data associated with the computing device 702.

Other system memory 714 can be available for use as well. The memory 714 can include multiple different types of memory with different performance characteristics. The processor 704 can include any general purpose processor and one or more hardware or software services, such as service 712 stored in storage device 710, configured to control the processor 704 as well as a special-purpose processor where software instructions are incorporated into the actual processor design. The processor 704 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 704 can be a microprocessor, a microcontroller, a digital signal processor (“DSP”), or a combination of these and/or other types of processors. In some embodiments, the processor 704 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 700, an input device 716 can represent any number of input mechanisms, such as a microphone for speech, a touch-sensitive screen for gesture or graphical input, keyboard, mouse, motion input, pen, and other such input devices. An output device 718 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 700. In some embodiments, the input device 716 and/or the output device 718 can be coupled to the computing device 702 using a remote connection device such as, for example, a communication interface such as the network interface 720 described herein. In such embodiments, the communication interface can govern and manage the input and output received from the attached input device 716 and/or output device 718. As may be contemplated, there is no restriction on operating on any particular hardware arrangement and accordingly the basic features here may easily be substituted for other hardware, software, or firmware arrangements as they are developed.

In some embodiments, the storage device 710 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described herein, the storage device 710 can include hardware and/or software services such as service 712 that can control or configure the processor 704 to perform one or more functions including, but not limited to, the methods, processes, functions, systems, and services described herein in various embodiments. In some embodiments, the hardware or software services can be implemented as modules. As illustrated in example computing system architecture 700, the storage device 710 can be connected to other parts of the computing device 702 using the system connection 706. In an embodiment, a hardware service or hardware module such as service 712, that performs a function can include a software component stored in a non-transitory computer-readable medium that, in connection with the necessary hardware components, such as the processor 704, connection 706, cache 708, storage device 710, memory 714, input device 716, output device 718, and so forth, can carry out the functions such as those described herein.

The payment instrument service, the systems of the payment instrument, and the systems and methods for dynamically, and in real-time, generating and authenticating dynamic verification values associated with different payment instruments can be performed using a computing system such as the example computing system illustrated in FIG. 7, using one or more components of the example computing system architecture 700. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for dynamically, and in real-time, generating and authenticating dynamic verification values associated with different payment instruments described herein by, for example, executing code using a processor such as processor 704 wherein the code is stored in memory such as memory 714 as described herein. One or more of a user device, a provider server or system, a database system, or other such devices, services, or systems may include some or all of the components of the computing system such as the example computing system illustrated in FIG. 7, using one or more components of the example computing system architecture 700 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 728. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 704 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 714 can be coupled to the processor 704 by, for example, a connector such as connector 706, or a bus. As used herein, a connector or bus such as connector 706 is a communications system that transfers data between components within the computing device 702 and may, in some embodiments, be used to transfer data between computing devices. The connector 706 can be a data bus, a memory bus, a system bus, or other such data transfer mechanism. Examples of such connectors include, but are not limited to, an industry standard architecture (ISA” bus, an extended ISA (EISA) bus, a parallel AT attachment (PATA” bus (e.g., an integrated drive electronics (IDE) or an extended IDE (EIDE) bus), or the various types of parallel component interconnect (PCI) buses (e.g., PCI, PCIe, PCI-104, etc.).

The memory 714 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 714 can also include magnetic or optical data storage media including read-only (e.g., CD ROM and DVD ROM) or otherwise (e.g., CD or DVD). The memory can be local, remote, or distributed.

As described herein, the connector 706 (or bus) can also couple the processor 704 to the storage device 710, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 710. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 706 can also couple the processor 704 to a network interface device such as the network interface 720. The interface can include one or more of a modem or other such network interfaces including, but not limited to those described herein. It will be appreciated that the network interface 720 may be considered to be part of the computing device 702 or may be separate from the computing device 702. The network interface 720 can include one or more of an analog modem, Integrated Services Digital Network (ISDN) modem, cable modem, token ring interface, satellite transmission interface, or other interfaces for coupling a computer system to other computer systems. In some embodiments, the network interface 720 can include one or more input and/or output (I/O) devices. The I/O devices can include, by way of example but not limitation, input devices such as input device 716 and/or output devices such as output device 718. For example, the network interface 720 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™ SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 702 can be connected to one or more additional computing devices such as computing device 724 via a network 722 using a connection such as the network interface 720. In such embodiments, the computing device 724 may execute one or more services 726 to perform one or more functions under the control of, or on behalf of, programs and/or services operating on computing device 702. In some embodiments, a computing device such as computing device 724 may include one or more of the types of components as described in connection with computing device 702 including, but not limited to, a processor such as processor 704, a connection such as connection 706, a cache such as cache 708, a storage device such as storage device 710, memory such as memory 714, an input device such as input device 716, and an output device such as output device 718. In such embodiments, the computing device 724 can carry out the functions such as those described herein in connection with computing device 702. In some embodiments, the computing device 702 can be connected to a plurality of computing devices such as computing device 724, each of which may also be connected to a plurality of computing devices such as computing device 724. Such an embodiment may be referred to herein as a distributed computing environment.

The network 722 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 722 can be wired connections, wireless connections, or combinations thereof. Communications via the network 722 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 722, within the computing device 702, within the computing device 724, or within the computing resources provider 728 can include information, which also may be referred to herein as content. The information may include text, graphics, audio, video, haptics, and/or any other information that can be provided to a user of the computing device such as the computing device 702. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 702 and presented to a user of the computing device 702 using forms that are perceptible via sight, sound, smell, taste, touch, or other such mechanisms. In some embodiments, communications over the network 722 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 702 and/or the computing device 724 can be connected to a computing resources provider 728 via the network 722 using a network interface such as those described herein (e.g. network interface 720). In such embodiments, one or more systems (e.g., service 730 and service 732) hosted within the computing resources provider 728 (also referred to herein as within “a computing resources provider environment”) may execute one or more services to perform one or more functions under the control of, or on behalf of, programs and/or services operating on computing device 702 and/or computing device 724. Systems such as service 730 and service 732 may include one or more computing devices such as those described herein to execute computer code to perform the one or more functions under the control of, or on behalf of, programs and/or services operating on computing device 702 and/or computing device 724.

For example, the computing resources provider 728 may provide a service, operating on service 730 to store data for the computing device 702 when, for example, the amount of data that the computing device 702 exceeds the capacity of storage device 710. In another example, the computing resources provider 728 may provide a service to first instantiate a virtual machine (VM) on service 732, use that VM to access the data stored on service 732, perform one or more operations on that data, and provide a result of those one or more operations to the computing device 702. Such operations (e.g., data storage and VM instantiation) may be referred to herein as operating “in the cloud,” “within a cloud computing environment,” or “within a hosted virtual machine environment,” and the computing resources provider 728 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 728 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 730 and service 732 may implement versions of various services (e.g., the service 712 or the service 726) on behalf of, or under the control of, computing device 702 and/or computing device 724. Such implemented versions of various services may involve one or more virtualization techniques so that, for example, it may appear to a user of computing device 702 that the service 712 is executing on the computing device 702 when the service is executing on, for example, service 730. As may also be contemplated, the various services operating within the computing resources provider 728 environment may be distributed among various systems within the environment as well as partially distributed onto computing device 724 and/or computing device 702.

In an embodiment, the computing device 702 can be connected to one or more additional computing devices and/or services such as merchant computing device 736 and/or a point-of-sale service 734 via the network 722 and using a connection such as the network interface 720. In an embodiment, the point-of-sale service 734 is separate from the merchant computing device 736. In an embodiment, the point-of-sale service 734 is executing on the merchant computing device 736. In an embodiment, the point-of-sale service 734 is executing as one or more services (e.g., the service 730 and/or the service 732) operating within the environment of the computing resources provider. As used herein, a point-of-sale service 734 is a service used by one or more merchants to manage sales transactions for customers, to process payment transactions for customers (e.g., payment instrument transactions), to manage inventory for merchants, to identify customers based on, for example, customer loyalty programs, and other such tasks.

In an embodiment, a customer and/or a merchant uses the merchant computing device 736 to interact with the point-of-sale service 734. In an embodiment, the merchant computing device 736 is a dedicated point-of-service (POS) terminal. In an embodiment, the merchant computing device 736 is a cash register system. In an embodiment, the merchant computing device 736 is an application or web service operating on a computing device such as the computing device 702 described herein. In such an embodiment, the application or web service may be provided by a financial services system (e.g., a bank, a transaction processing system, an inventory management system, or some other such financial services system). In an embodiment, the merchant computing device 736 includes an auxiliary device or system to execute tasks associated with the point-of-sale service 734 (e.g., a payment instrument processing device attached to a smart phone or tablet). In an embodiment, the merchant computing device 736 is a kiosk that is located at a merchant location (e.g., in a merchant's “brick and mortar” store), in a high traffic area (e.g., in a mall or in an airport concourse), or at some other such location. In such an embodiment, the kiosk may include additional branding elements to allow associating the kiosk with a vendor. In an embodiment, the merchant computing device 736 is a virtual device (e.g., a virtual kiosk) such as the virtual devices described herein. Although not illustrated here, in an embodiment, the merchant computing device 736 may be one of a plurality of devices that may be interconnected using a network such as the network 722.

In an embodiment, the computing device 702 can be connected to one or more additional computing devices and/or services such as a payment instrument service 738 via the network 722 and using a connection such as the network interface 720. In an embodiment, the payment instrument service 738 connects directly with the point of sale service 734. In an embodiment, elements of the payment instrument service 738 are executing on the merchant computing device 736. In an embodiment, the payment instrument service 738 is executing as one or more services (e.g., the service 730 and/or the service 732) operating within the environment of the computing resources provider. As used herein, a payment instrument service 738 is a service used by various entities (e.g., merchants, financial institutions, and account holders) to manage payment instrument transactions (e.g., sales and payments), process payment, to issue payment instruments to account holders, and to perform other such actions.

In an embodiment, elements of the payment instrument service 738 are running as an application or web service operating on a computing device such as the computing device 702 described herein. In such an embodiment, the application or web service of the payment instrument service 738 may be provided by a financial services system (e.g., a bank, a transaction processing system, an inventory management system, or some other such financial services system). In an embodiment, elements of the payment instrument service 738 are running on an auxiliary device or system configured to execute tasks associated with the payment instrument service 738 (e.g., uses a payment instrument processing device attached to a smart phone or tablet). In an embodiment, elements of the payment instrument service 738 are running on virtual device such as those described herein. Although not illustrated here, in an embodiment, the payment instrument service 738 may be running on one or more of a plurality of devices that may be interconnected using a network such as the network 722.

In an embodiment, the computing device 702 can be connected to one or more additional computing devices and/or services such as a evaluation service 740 via the network 722 and using a connection such as the network interface 720. In an embodiment, the evaluation service 740 is an element of the payment instrument service 738. In an embodiment, the evaluation service 740 is separate from the payment instrument service 738. In an embodiment, the evaluation service 740 connects directly with the point of sale service 734. In an embodiment, elements of the evaluation service 740 are executing on the merchant computing device 736. In an embodiment, the evaluation service 740 is executing as one or more services (e.g., the service 730 and/or the service 732) operating within the environment of the computing resources provider. As used herein, a evaluation service 740 is a service used by one or more merchants to authenticate transactions associated with payment instruments. An authentication service may be a third-party service that provides secure and verified authorization of the transactions.

In an embodiment, elements of the evaluation service 740 are running as an application or web service operating on a computing device such as the computing device 702 described herein. In such an embodiment, the application or web service of the authentication service 740 may be provided by a financial services system (e.g., a bank, a transaction processing system, an inventory management system, or some other such financial services system). In an embodiment, elements of the evaluation service 740 are running on an auxiliary device or system configured to execute tasks associated with the evaluation service 740 (e.g., provides authentication using payment instrument processing device attached to a smart phone or tablet). In an embodiment, elements of the evaluation service 740 are running on virtual device such as those described herein. Although not illustrated here, in an embodiment, the evaluation service 740 may be running on one or more of a plurality of devices that may be interconnected using a network such as the network 722.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 702) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described herein. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram. Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 702.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described herein. The elements and acts of the various examples described herein can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described herein to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described herein may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use.

What is claimed is:

1. A computer-implemented method, comprising:
receiving an authorization request associated with a payment instrument, wherein the authorization request includes record data and a dynamic verification value corresponding to the payment instrument;
obtaining a secret code associated with the payment instrument, wherein the secret code is obtained using the record data;
dynamically generating a reference dynamic verification value corresponding to the payment instrument, wherein the reference dynamic verification value is dynamically generated by processing the record data, the secret code, and a current time interval through a hashing algorithm;
comparing the dynamic verification value to the reference dynamic verification value; and
fulfilling the authorization request when the dynamic verification value matches the reference dynamic verification value.

2. The computer-implemented method of claim 1, wherein the record data includes a portion of a Universally Unique Identifier (UUID) corresponding to the payment instrument.

3. The computer-implemented method of claim 1, further comprising:
receiving a request to enable generation of dynamic verification values for the payment instrument, wherein the request includes the secret code and the record data;
storing the secret code and the record data; and
transmitting a response, wherein when the response is received at a user device, the user device uses the record data and the secret code to generate new dynamic verification values.

4. The computer-implemented method of claim 1, wherein the payment instrument is associated with a static verification value, and wherein the dynamic verification value and the static verification value have a same format.

5. The computer-implemented method of claim 1, wherein the dynamic verification value is generated as a result of the record data being obtained from the payment instrument through a wireless communications session.

6. The computer-implemented method of claim 1, further comprising:
comparing the dynamic verification value to a static verification value associated with the payment instrument when the dynamic verification value does not match the reference dynamic verification value; and
fulfilling the authorization request when the dynamic verification value matches the static verification value.

7. The computer-implemented method of claim 1, wherein the secret code is a shared secret generated through a secure communications session with an application executing on a user device, and wherein the shared secret is generated in response to detection of the payment instrument through the application.

8. A system, comprising:
one or more processors; and
memory storing thereon instructions that, as a result of being executed by the one or more processors, cause the system to:
receive an authorization request associated with a payment instrument, wherein the authorization request includes record data and a dynamic verification value corresponding to the payment instrument;
obtain a secret code associated with the payment instrument, wherein the secret code is obtained using the record data;
dynamically generate a reference dynamic verification value corresponding to the payment instrument, wherein the reference dynamic verification value is dynamically generated by processing the record data, the secret code, and a current time interval through a hashing algorithm;
compare the dynamic verification value to the reference dynamic verification value; and
fulfill the authorization request when the dynamic verification value matches the reference dynamic verification value.

9. The system of claim 8, wherein the record data includes a portion of a Universally Unique Identifier (UUID) corresponding to the payment instrument.

10. The system of claim 8, wherein the instructions further cause the system to:
receive a request to enable generation of dynamic verification values for the payment instrument, wherein the request includes the secret code and the record data;
store the secret code and the record data; and
transmit a response, wherein when the response is received at a user device, the user device uses the record data and the secret code to generate new dynamic verification values.

11. The system of claim 8, wherein the payment instrument is associated with a static verification value, and wherein the dynamic verification value and the static verification value have a same format.

12. The system of claim 8, wherein the dynamic verification value is generated as a result of the record data being obtained from the payment instrument through a wireless communications session.

13. The system of claim 8, wherein the instructions further cause the system to:
compare the dynamic verification value to a static verification value associated with the payment instrument when the dynamic verification value does not match the reference dynamic verification value; and
fulfill the authorization request when the dynamic verification value matches the static verification value.

14. The system of claim 8, wherein the secret code is a shared secret generated through a secure communications session with an application executing on a user device, and wherein the shared secret is generated in response to detection of the payment instrument through the application.

15. A non-transitory computer-readable storage medium storing thereon executable instructions that, as a result of being executed by one or more processors of a computer system, cause the computer system to:
receive an authorization request associated with a payment instrument, wherein the authorization request includes record data and a dynamic verification value corresponding to the payment instrument;
obtain a secret code associated with the payment instrument, wherein the secret code is obtained using the record data;
dynamically generate a reference dynamic verification value corresponding to the payment instrument, wherein the reference dynamic verification value is dynamically generated by processing the record data, the secret code, and a current time interval through a hashing algorithm;
compare the dynamic verification value to the reference dynamic verification value; and
fulfill the authorization request when the dynamic verification value matches the reference dynamic verification value.

16. The non-transitory computer-readable storage medium of claim 15, wherein the record data includes a portion of a Universally Unique Identifier (UUID) corresponding to the payment instrument.

17. The non-transitory computer-readable storage medium of claim 15, wherein the executable instructions further cause the computer system to:
receive a request to enable generation of dynamic verification values for the payment instrument, wherein the request includes the secret code and the record data;
store the secret code and the record data; and
transmit a response, wherein when the response is received at a user device, the user device uses the record data and the secret code to generate new dynamic verification values.

18. The non-transitory computer-readable storage medium of claim 15, wherein the payment instrument is associated with a static verification value, and wherein the dynamic verification value and the static verification value a the same format.

19. The non-transitory computer-readable storage medium of claim 15, wherein the dynamic verification value is generated as a result of the record data being obtained from the payment instrument through a wireless communications session.

20. The non-transitory computer-readable storage medium of claim 15, wherein the executable instructions further cause the computer system to:
compare the dynamic verification value to a static verification value associated with the payment instrument when the dynamic verification value does not match the reference dynamic verification value; and
fulfill the authorization request when the dynamic verification value matches the static verification value.

21. The non-transitory computer-readable storage medium of claim 15, wherein the secret code is a shared secret generated through a secure communications session with an application executing on a user device, and wherein the shared secret is generated in response to detection of the payment instrument through the application.
